(19) United States
(12) Patent Application Publication
(10) Pub. No.: US 2022/0020536 A1
(43) Pub. Date: Jan. 20, 2022

(54) POWER STORAGE MODULE AND METHOD FOR PRODUCING POWER STORAGE MODULE

(71) Applicant: Panasonic Intellectual Property Management Co., Ltd., Osaka (JP)

(72) Inventors: Nobuhiko HAYASHI, Kyoto (JP); Kiyoshi WAKINAKA, Osaka (JP); Hideyasu UCHIYAMA, Miyagi (JP)

(21) Appl. No.: 17/312,386

(22) PCT Filed: Dec. 2, 2019
(86) PCT No.: PCT/JP2019/047049

§ 371 Date: Jun. 9, 2021

(30) Foreign Application Priority Data
Dec. 11, 2018 (JP) 2018-231990
Feb. 28, 2019 (JP) 2019-036807

(51) Int. Cl. H01G 11/10; H01G 11/78; H01G 11/74

(52) U.S. Cl. CPC H01G 11/10; H01G 11/74; H01G 11/78

(57) ABSTRACT

A power storage module is configured to be mounted to a predetermined setting part, and includes a plurality of power storage devices and a case where the plurality of power storage devices are housed in a state of being arranged. Each of the plurality of power storage devices includes a positive electrode lead terminal and a negative electrode lead terminal which protrude from an end face of the power storage device. The case includes a body part where the plurality of power storage devices are housed, and a fixation part configured to mount the power storage module to the setting part. The fixation part is provided at each of both lateral faces in a direction in which the positive electrode lead terminals and the negative electrode lead terminals in the body part protrude.

### CROSS-REFERENCE OF RELATED APPLICATIONS

This application is the U.S. National Phase under 35 U.S.C. § 371 of International Patent Application No. PCT/JP2019/047049, filed on Dec. 2, 2019, which in turn claims the benefit of Japanese Application No. 2019-036807, filed on Feb. 28, 2019, and Japanese Application No. 2018-231990, filed Dec. 11, 2018, the entire disclosures of which Applications are incorporated by reference herein.

### TECHNICAL FIELD

The present invention relates to a power storage module and a method for producing the power storage module.

### BACKGROUND ART

Patent Literature 1 describes a power storage unit in which a pair of brackets for mounting to a mounting target such as a vehicle are provided at the front and rear of a unit body part that has a holder for holding a plurality of capacitors inside a case.

In this power storage unit, a plurality of recesses are provided so as to be arranged in the front-rear direction in each of left and right rows on the upper face side of the holder. Each recess in each of the left and right rows receives a capacitor such that the lead terminals thereof are directed toward the corresponding left or right outer side.

### CITATION LIST

### [Patent Literature]

[PTL 1] Japanese Laid-Open Patent Publication No. 2018-142571

### SUMMARY OF THE INVENTION

### Problems to be Solved by the Invention

In the above power storage unit, the lateral face sides at the front and rear of the case are fixed to the mounting target via the brackets, but the lateral face side at the left and right of the case are in free states. Therefore, in a state where the above power storage unit is mounted to the mounting target, when vibration has occurred in the mounting target, up-down deflection according to the vibration easily occurs in the case in the left-right direction.

In each capacitor held in the holder inside the case, the lead terminals are directed toward the left-right direction. Therefore, when the case has been deflected upwardly and downwardly in the left-right direction, the lead terminals are easily deflected upwardly and downwardly in accordance therewith. Accordingly, as for the above power storage unit, it is a concern that, between the lead terminals and the connection destination thereof, e.g., a circuit board, separation at the connection portion may occur and breakage of the lead terminals may occur.

In a case where the terminal part extending from the end face of the capacitor is not the lead terminals and is in a shape that is shorter than and greater in the diameter than the lead terminals, breakage of the terminal part is less likely to occur unlike the lead terminals, but occurrence of separation of the connection portion between the terminal part and the connection destination thereof is a concern.

Therefore, in the above power storage unit, in order to avoid such a situation, rigidity of the entirety of the case needs to be increased, and reduction of the weight and thickness of the case has been difficult.

Therefore, an object of the present invention is to provide a power storage module that facilitates reduction of the weight and thickness of the case.

Another object of the present invention is to provide a power storage module and a power storage module production method that enable welding of the terminal part of a power storage device and a bus bar to be performed smoothly.

Still another object of the present invention is to provide, in a configuration in which the power storage device is disposed in a case in a state of being closed from the outside, a power storage module in which water is less likely to enter the case.

### Solution to the Problems

A first mode of the present invention relates to a power storage module configured to be mounted to a predetermined setting part and including: a plurality of power storage devices; and a case in which the plurality of power storage devices are housed in a state of being arranged. In the power storage module according to the present mode, each of the plurality of power storage devices includes a first end face and a second end face opposed, back to back, to the first end face, and includes a terminal part protruding from the first end face, and the case includes a body part in which the plurality of power storage devices are housed, and a fixation part configured to mount the power storage module to the setting part. The fixation part is provided at each of both lateral faces in a direction in which the terminal part in the body part protrudes.

A second mode of the present invention relates to a power storage module. The power storage module according to the present mode includes: a plurality of power storage devices; a case in which the plurality of power storage devices are housed in a state of being arranged; and a bus bar which is housed in the case, and to which a terminal part protruding from an end face of each of the plurality of power storage devices is connected. Here, the case includes a bottom face portion, and an opening portion which faces the bottom face portion and through which the plurality of power storage devices are passed when being housed into the case. Further, in the bottom face portion, a penetration hole penetrating the bottom face portion is provided at a position at which a connection portion between the terminal part and the bus bar is seen through the penetration hole from outside of the case.

A third mode of the present invention relates to a power storage module production method. The production method according to the present mode includes: a step of housing, inside a case including a bottom face portion and an opening portion facing the bottom face portion, a bus bar and a plurality of power storage devices through the opening portion, and of bringing together the bus bar and a terminal part protruding from an end face of each of the plurality of power storage devices; and a step of causing a first welding member passed through the opening portion and a second welding member passed through a penetration hole penetrating the bottom face portion to face each other with a connection portion therebetween, the connection portion having been formed by bringing the terminal part and the bus bar together, and of welding the connection portion by using the first welding member and the second welding member.

A fourth mode of the present invention relates to a power storage module. The power storage module according to the present mode includes: a plurality of power storage devices; a case in which the plurality of power storage devices are housed in a state of being closed from outside; a bus bar housed in the case and configured to be electrically connected to each of the plurality of power storage devices; a communication hole which is provided in the case and through which inside and outside of the case are continuous with each other; an external connection terminal configured to be inserted into the communication hole, one end side of the external connection terminal being configured to be electrically connected to the bus bar inside the case, another end side of the external connection terminal being configured to be exposed to outside of the case to be connected to an external terminal; and an annular sealing member interposed between an outer face of the external connection terminal and an inner face of the communication hole.

### Advantageous Effects of the Invention

According to the present invention, a power storage module that facilitates reduction of the weight and thickness of the case can be provided.

Further, according to the present invention, a power storage module and a power storage module production method that enable welding of the terminal part of the power storage device and the bus bar to be performed smoothly can be provided.

Further, according to the present invention, in a configuration in which the power storage device is disposed in a case in a state of being closed from the outside, a power storage module in which water is less likely to enter the case can be provided.

The effects and the significance of the present invention will be further clarified by the description of the embodiment below. However, the embodiment below is merely an example for implementing the present invention. The present invention is not limited to the embodiment below in any way.

### BRIEF DESCRIPTION OF THE DRAWINGS

FIG. 1 is a perspective view of a power storage module according to an embodiment.

FIG. 2 is a perspective view of the power storage module in a state of being reversed, according to the embodiment.

FIG. 3 is a perspective view of the power storage module in a state where a cover is removed, according to the embodiment.

FIG. 4 is a perspective view of the power storage module in a state where the cover and a circuit board are removed, according to the embodiment.

FIG. 5A is a perspective view of a power storage device according to the embodiment, and FIG. 5B is a perspective view of the circuit board according to the embodiment.

FIG. 6 is a perspective view of a case body according to the embodiment.

FIG. 7A is a plan view of the case body according to the embodiment, and FIG. 7A is a bottom view of the case body according to the embodiment.

FIG. 8A is a perspective view of the cover according to the embodiment, and FIG. 8B is a perspective view of the cover in a state of being reversed, according to the embodiment.

FIG. 9A is a perspective view of a reverse face cover according to the embodiment, and FIG. 9B is a perspective view of the reverse face cover in a state of being reversed, according to the embodiment.

FIGS. 10A, 10B, and 10C are perspective views of a first relay terminal, a second relay terminal, and a third relay terminal, respectively, according to the embodiment.

FIG. 11 is a perspective view of an external connection terminal according to the embodiment.

FIG. 12 is a flow chart showing a procedure of assembling the power storage module, according to the embodiment.

FIG. 13 is a cross-sectional view of a major part showing the periphery of a terminal attachment portion on the left side after a terminal/power storage device attachment step, according to the embodiment.

FIG. 14A is a bottom view of an upper part of the power storage module after the terminal/power storage device attachment step, and FIG. 14B is an A-A′ cross-sectional view of FIG. 14A, according to the embodiment.

FIGS. 15A and 15B are bottom views of a major part of the power storage module showing a peripheral portion of six penetration holes before a reverse face cover is attached and after the reverse face cover is attached, respectively, according to Modification 1.

FIGS. 16A, 16B, and 16C are each a schematic plan view of a fixation part according to another modification.

### BEST MODE FOR CARRYING OUT THE INVENTION

Hereinafter, a power storage module 1 according to the present embodiment will be described with reference to the drawings. For convenience, front, rear, left, right, up, and down directions are indicated in the drawings, as appropriate. It should be noted that the directions in the drawings merely indicate relative directions with respect to the power storage module 1, and do not indicate absolute directions.

In the present embodiment, an end face 100a corresponds to “first end face” described in the claims, and an end face 100b corresponds to “second end face” described in the claims. A positive electrode lead terminal 130 corresponds to “terminal part” and “first terminal part” described in the claims. A negative electrode lead terminal 140 corresponds to “terminal part” and “second terminal part” described in the claims. A first relay terminal 200, a second relay terminal 300, and a third relay terminal 400 correspond to “bus bar” described in the claims. Terminal connection parts 210, 310, 410 correspond to “extension part” described in the claims. Board connection parts 220, 320, 420 correspond to “protrusion part” described in the claims. Obverse faces 210a, 310a, 410a corresponds to “second face” described in the claims, and reverse faces 210b, 310b, 410b correspond to “first face” described in the claims. An O-ring 510 corresponds to “sealing member” described in the claims. Through-holes 601, 602, 603 correspond to “hole portion” described in the claims. A left lateral face portion 714 and a right lateral face portion 715 correspond to “lateral face portion” described in the claims. A mounting hole 722 corresponds to “mounting portion” described in the claims. A cover 800 corresponds to “first closing part” and “first lid” described in the claims. A reverse face cover 850 corresponds to “second lid” described in the claims. A wall portion 791 and a reverse face cover 850 form “second closing part” described in the claims. A screw 920 corresponds to “coupling member” described in the claims. An adhesive A2 corresponds to “first sealing part” described in the claims, and an adhesive A3 corresponds to “second sealing part” described in the claims. A first electrode probe E1 corresponds to “first electrode member” described in the claims, and a second electrode probe E2 corresponds to “second electrode member” described in the claims.

However, the above description is merely for providing correspondence between the configurations described in the claims and configurations of the embodiment. The above correspondence does not limit the invention described in the claims to the configurations of the embodiment in any way.

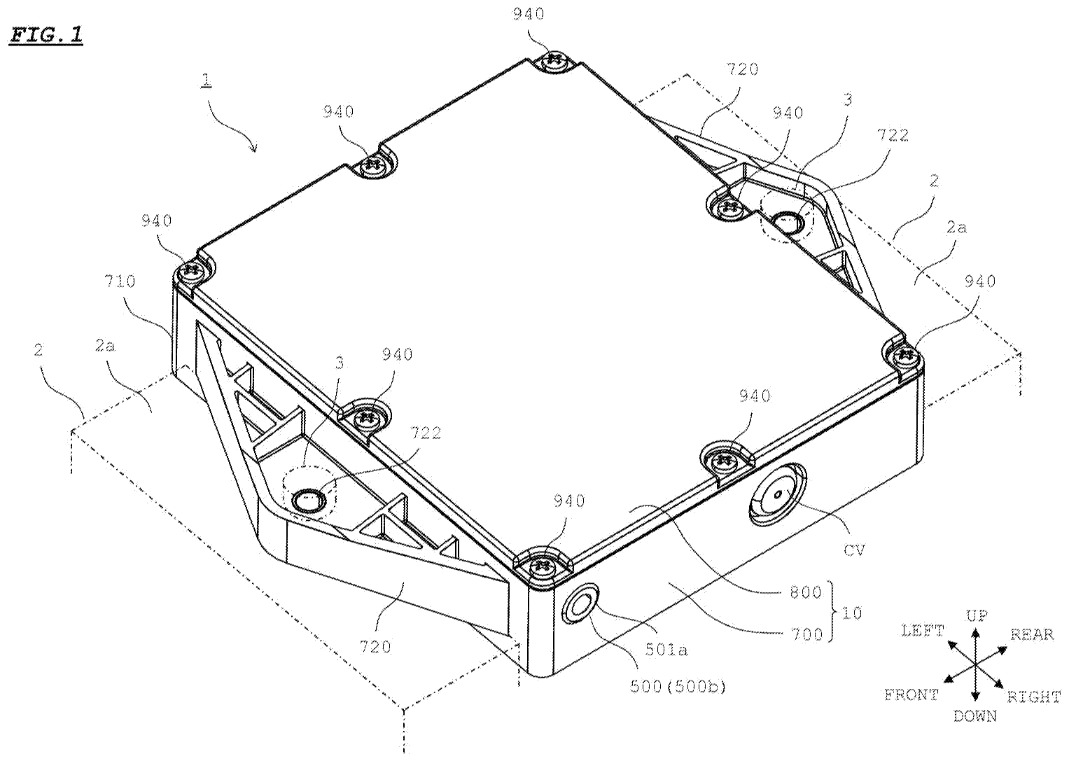

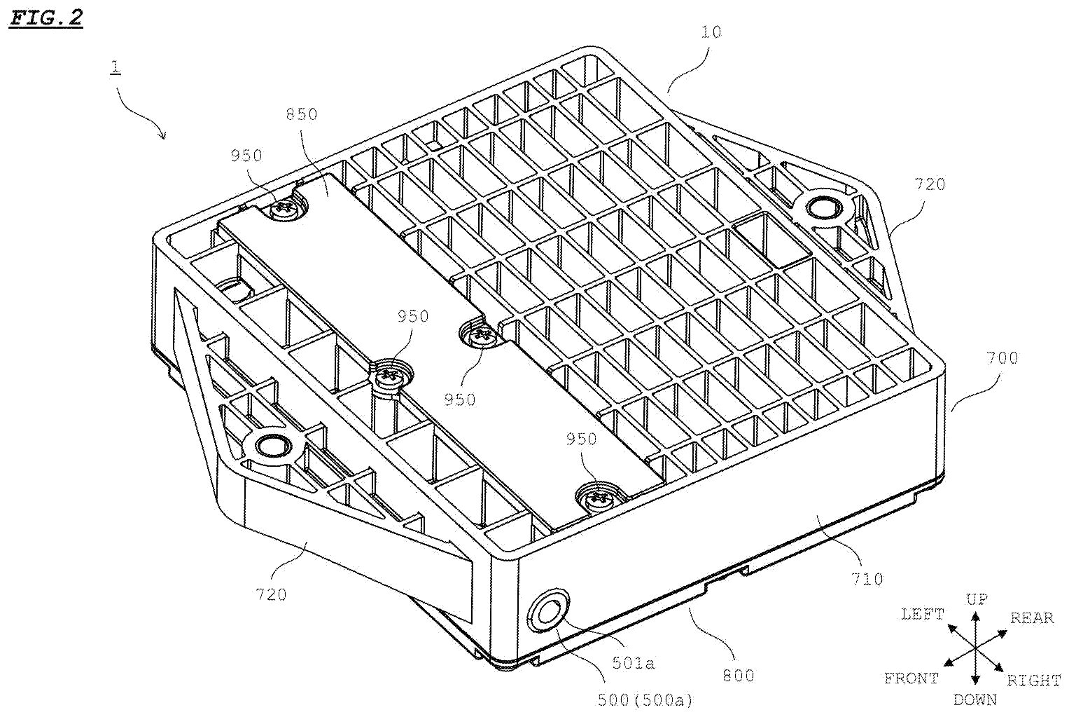

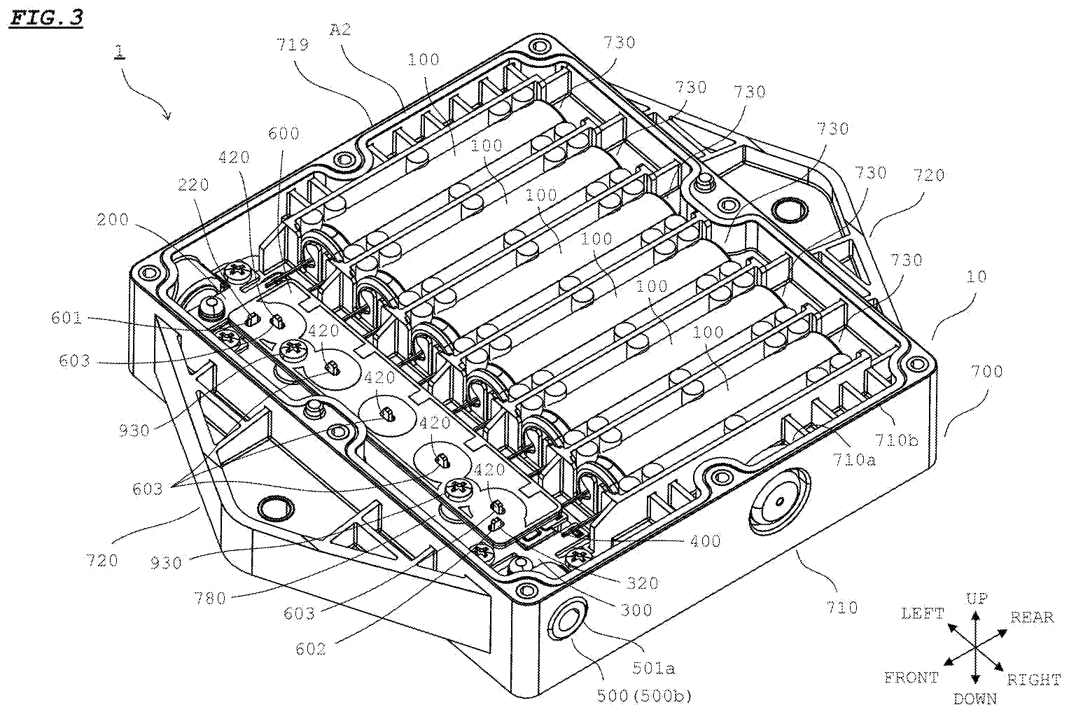

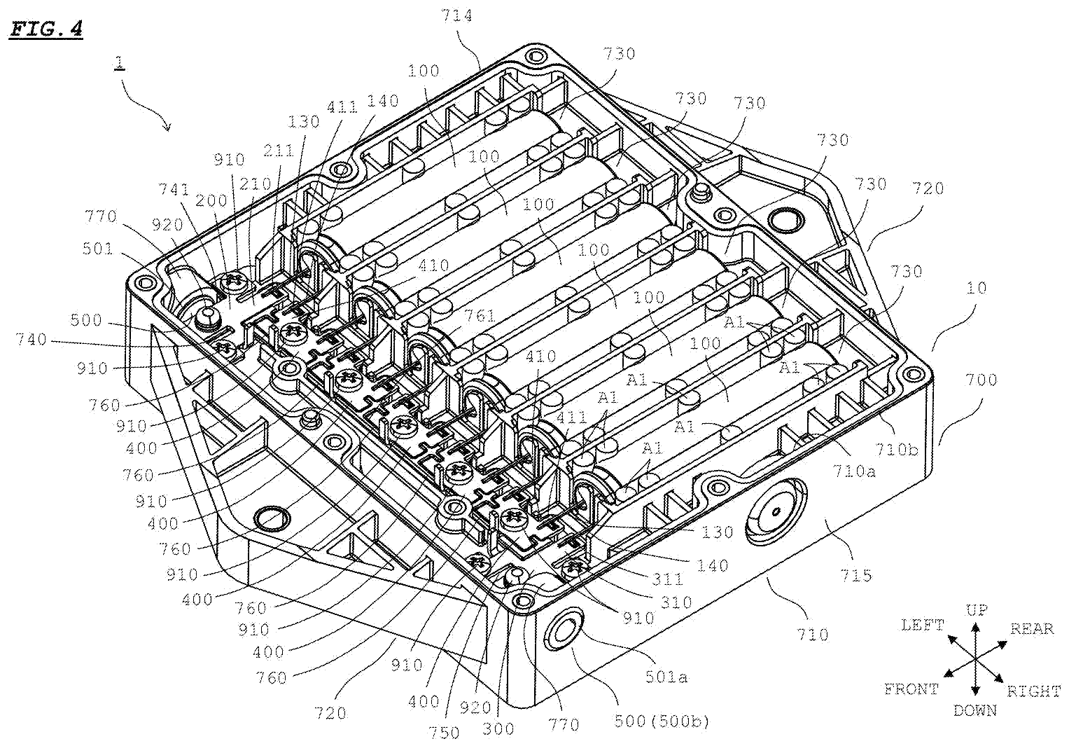

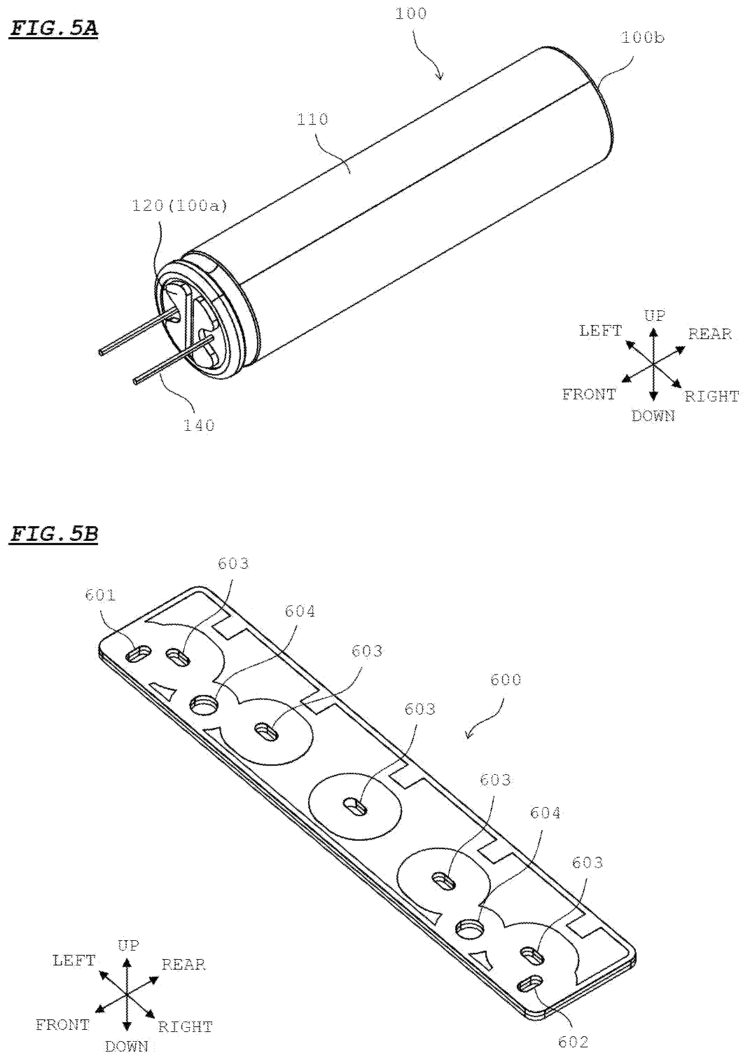

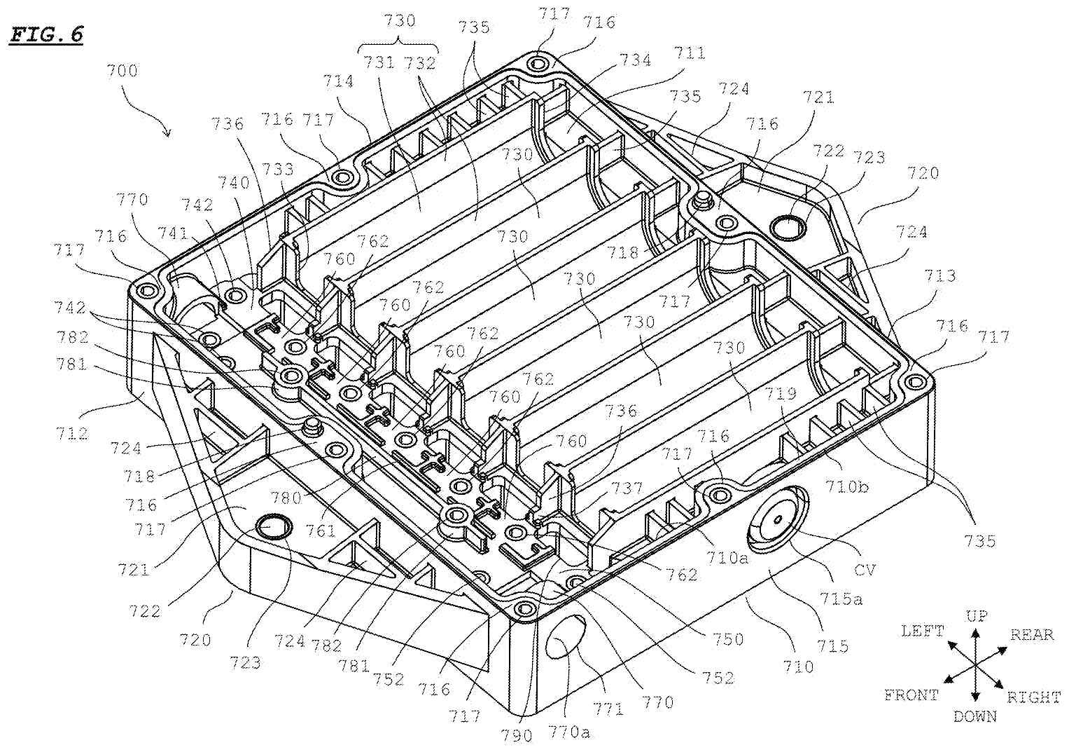

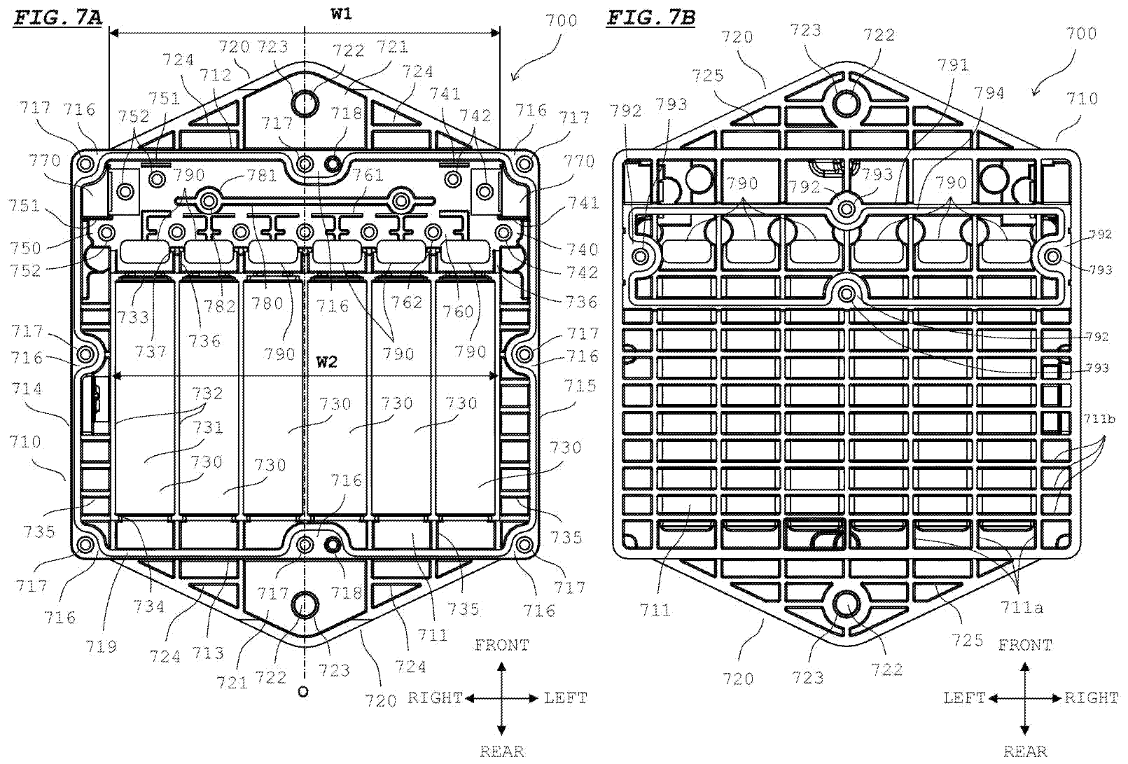

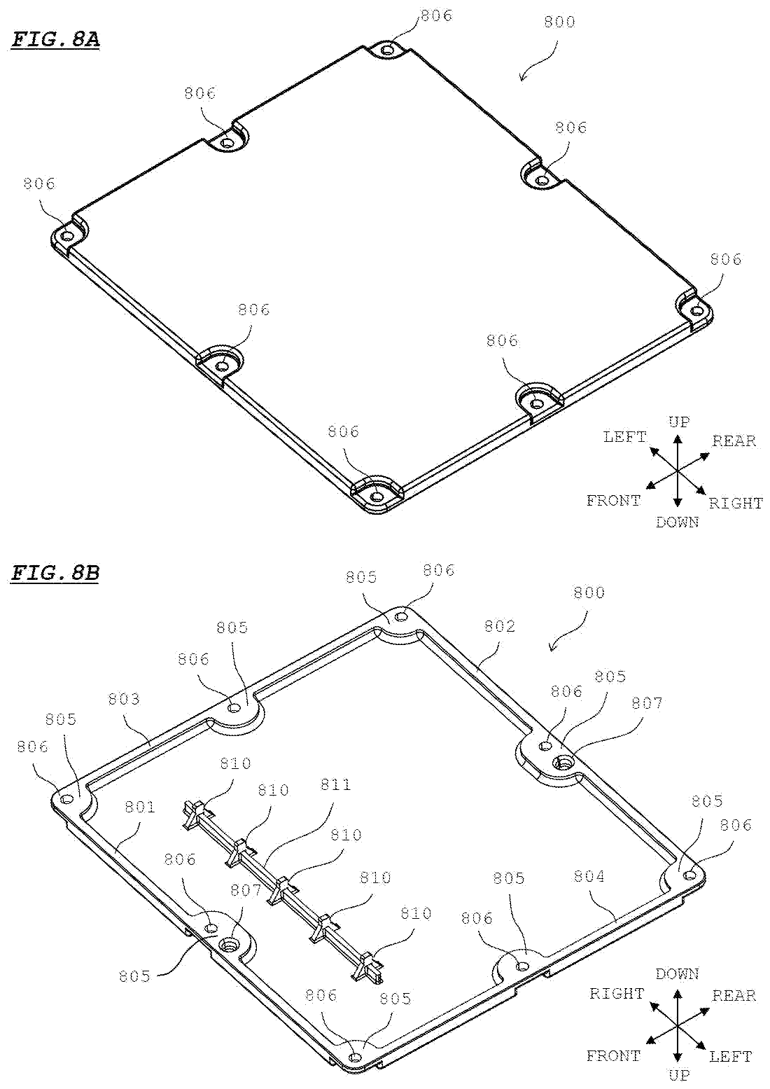

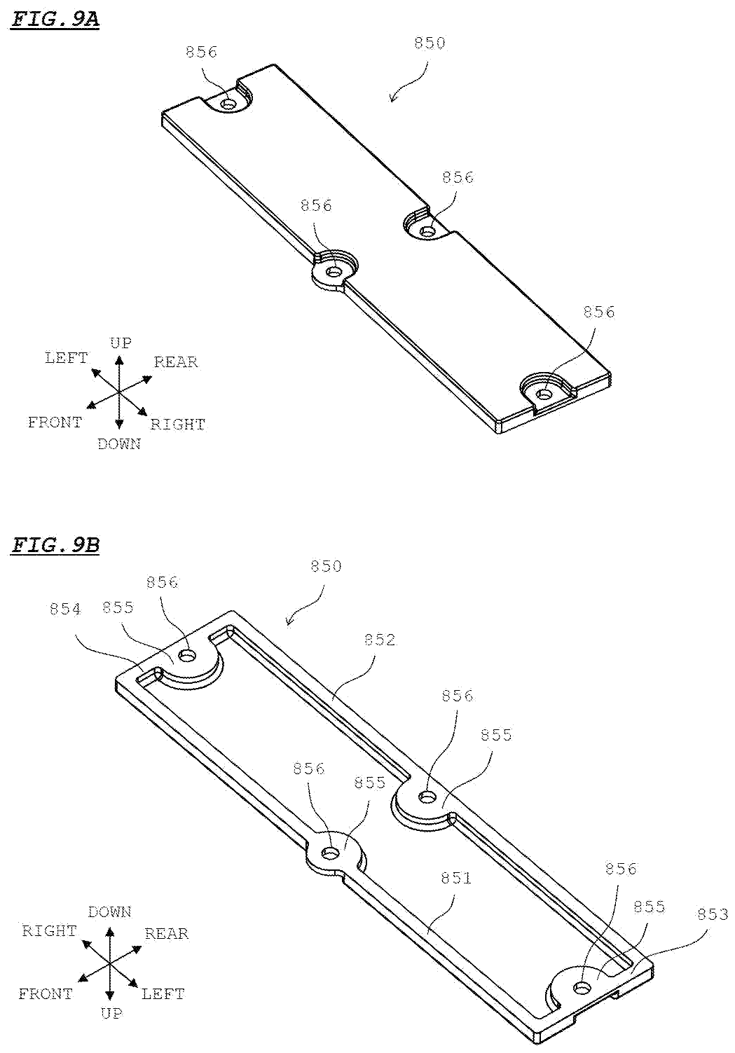

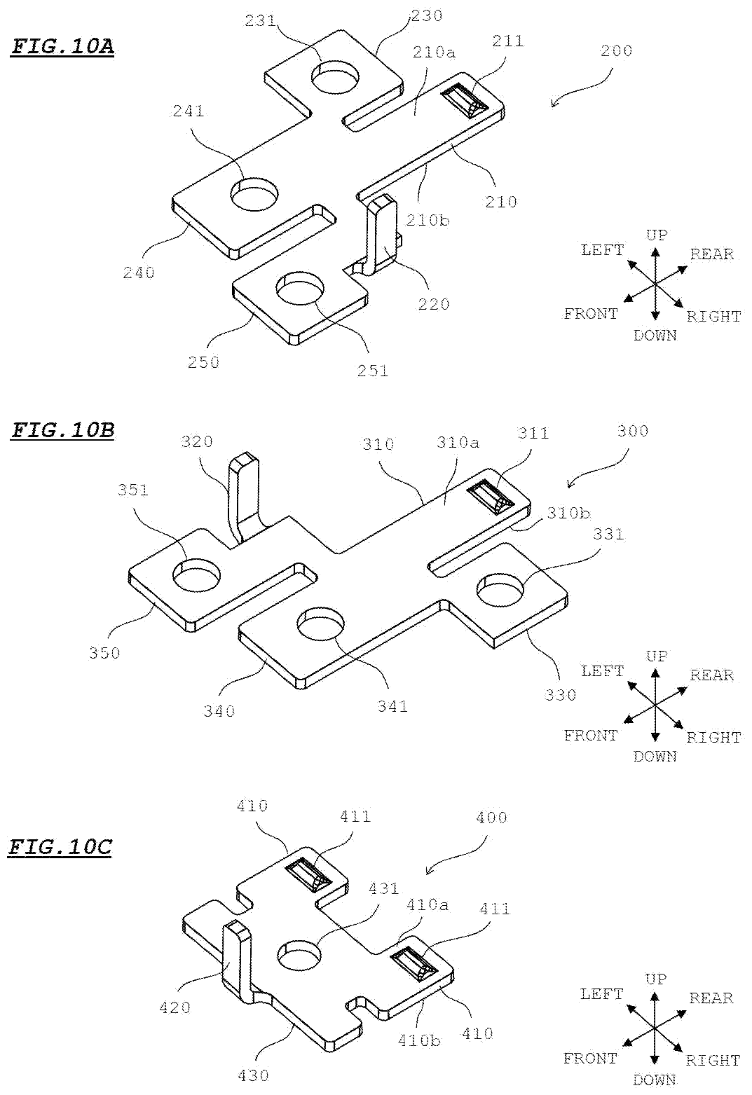

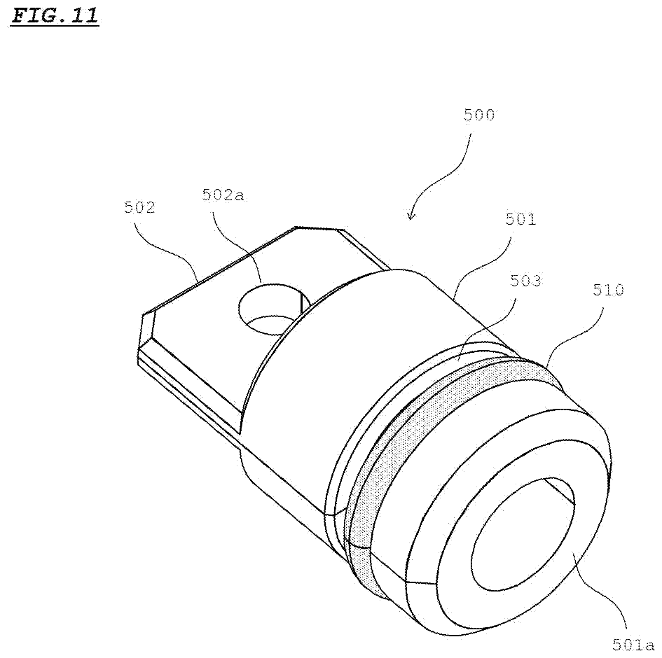

FIG. 1 is a perspective view of a power storage module 1. FIG. 2 is a perspective view of the power storage module 1 in a state of being reversed. FIG. 3 is a perspective view of the power storage module 1 in a state where a cover 800 is removed. FIG. 4 is a perspective view of the power storage module 1 in a state where the cover 800 and a circuit board 600 are removed. FIG. 5A is a perspective view of a power storage device 100, and FIG. 5B is a perspective view of the circuit board 600. FIG. 6 is a perspective view of a case body 700. FIG. 7A is a plan view of the case body 700, and FIG. 7B is a bottom view of the case body 700. FIG. 8A is a perspective view of the cover 800, and FIG. 8B is a perspective view of the cover 800 in a state of being reversed. FIG. 9A is a perspective view of a reverse face cover 850, and FIG. 9B is a perspective view of the reverse face cover 850 in a state of being reversed. FIGS. 10A, 10B, and 10C are perspective views of a first relay terminal 200, a second relay terminal 300, and a third relay terminal 400, respectively. FIG. 11 is a perspective view of an external connection terminal 500. In FIG. 1, for convenience, a setting part 2 to which the power storage module 1 is mounted, and bolts 3 that are used in the mounting are schematically depicted by chain lines.

The power storage module 1 includes: a case 10; six power storage devices 100 housed in the case 10; the first relay terminal 200; the second relay terminal 300; five third relay terminals 400; two external connection terminals 500; and the circuit board 600. The case 10 includes the case body 700 of which the upper face is open; and the cover 800 covering the upper face of the case body 700. The case 10 includes the reverse face cover 850.

Each power storage device 100 is, for example, an electric double layer capacitor, and has a cylindrical shape (columnar shape). The power storage device 100 may be a capacitor, such as a lithium ion capacitor, other than the electric double layer capacitor. A power storage device 100 in which a conductive polymer is used as an active material of the positive electrode may be adopted. Examples of the conductive polymer include polyaniline, polypyrrole, or polythiophene, derivatives thereof, and the like. A plurality of types of conductive polymers may be used. Further, the power storage device 100 may not necessarily have a cylindrical shape, and may have a polygonal-tube-like shape (polygonal-column-like shape).

As shown in FIG. 5A, each power storage device 100 includes: a container 110 having a bottomed cylindrical shape and containing a device element (not shown) and an electrolytic solution; a sealing body 120 which is formed from an elastic material containing a rubber component and which seals the opening of the container 110; and a positive electrode lead terminal 130 and a negative electrode lead terminal 140 which are drawn from the sealing body 120 to the outside. The positive electrode lead terminal 130 is electrically connected to the positive electrode of the device element, and the negative electrode lead terminal 140 is electrically connected to the negative electrode of the device element. The sealing body 120 forms an end face 100a, which is one of two end faces 100a, 100b opposed back to back to each other, of the power storage device 100. The positive electrode lead terminal 130 and the negative electrode lead terminal 140 protrude from the end face 100a. The direction in which the positive electrode lead terminal 130 and the negative electrode lead terminal 140 protrude is the direction connecting the two end faces 100a, 100b.

The case body 700, the cover 800, and the reverse face cover 850 are each formed from a resin material such as polybutylene terephthalate (PBT) and polyphenylene sulfide (PPS).

As shown in FIG. 6, and FIGS. 7A and 7B, the case body 700 includes: a body part 710 in which six power storage devices 100 and the like are housed; and two fixation parts 720 formed integrally with the body part 710.

The body part 710 includes: a bottom face portion 711 in a quadrangular shape; and a front lateral face portion 712, a rear lateral face portion 713, a left lateral face portion 714, and a right lateral face portion 715, which surround the four sides of the bottom face portion 711. The thickness of the bottom face portion 711 is significantly larger than the thickness of each of the front lateral face portion 712, the rear lateral face portion 713, the left lateral face portion 714, and the right lateral face portion 715. Therefore, on the outer bottom face side of the bottom face portion 711, a lightening structure in which a large number of ribs 711a extending in the front-rear direction and a large number of ribs 711b extending in the left-right direction are arranged in a lattice shape, is adopted. Since the thickness of the bottom face portion 711 is large, rigidity of the case body 700 is increased.

In the body part 710, bosses 716 are formed at four corner portions of the body part 710 and a center portion of each of the lateral face portions 712, 713, 714, 715. A nut 717 made of metal is embedded in each boss 716. A projection 718 for positioning is formed in the boss 716 of each of the front lateral face portion 712 and the rear lateral face portion 713. In the body part 710, the inner side of the upper end face of each of the front lateral face portion 712, the rear lateral face portion 713, the left lateral face portion 714, and the right lateral face portion 715 is lower than the remainder thereof in a stepped manner, so as to be used as an adhesion margin 719 to which an adhesive (described later) is applied.

The entirety of the upper face of the body part 710 serves as an opening portion 710a. An edge portion 710b surrounding the opening portion 710a is formed by the upper end faces of the front lateral face portion 712, the rear lateral face portion 713, the left lateral face portion 714, and the right lateral face portion 715. The opening portion 710a faces the bottom face portion 711.

In a substantially center region inside the body part 710, six holders 730 that are continuous in the left-right direction are provided integrally with the bottom face portion 711. Each holder 730 is formed in a cylindrical shape having a U-shaped cross-section. Each holder 730 includes: a circular-arc-shaped portion 731 having a semicircular arc shape; and linear portions 732 each having a linear shape and extending from both ends of the circular-arc-shaped portion 731 to the opening end thereof. The circular-arc-shaped portion 731 is recessed downwardly with respect to the inner face of the bottom face portion 711. Adjacent holders 730 share a linear portion 732. The end face on the front side of each holder 730 is provided with an opening portion 733 of which the upper side is open. The end face on the rear side of each holder 730 is open, with a U-shaped rib 734 for reinforcement remaining at an edge portion. A large number of ribs 735 for reinforcement are provided in the space between the six holders 730, and the rear lateral face portion 713, the left lateral face portion 714, and the right lateral face portion 715.

At the front of each holder 730, a rib 736 is formed so as to be continuous from the linear portion 732. In each of five ribs 736 excluding the ribs 736 on both outer sides, a front end portion is formed in a hook-like shape so as to serve as a placement portion 737 on which the circuit board 600 is placed.

A first mounting portion 740 to which the first relay terminal 200 is mounted; a second mounting portion 750 to which the second relay terminal 300 is mounted; and five third mounting portions 760 to which the third relay terminals 400 are mounted, are provided at the front of the seven ribs 736 in the bottom face portion 711. The first mounting portion 740 is provided in a left end portion of the bottom face portion 711, the second mounting portion 750 is provided in a right end portion of the bottom face portion 711, and the five third mounting portions 760 are provided so as to be arranged in the left-right direction between the first mounting portion 740 and the second mounting portion 750.

The bottom face portion 711 is provided with two ribs 741 for positioning the first relay terminal 200 at the first mounting portion 740, and is provided with two ribs 751 for positioning the second relay terminal 300 at the second mounting portion 750. In addition, the bottom face portion 711 is provided with a rib 761 for positioning the five third relay terminals 400 at the third mounting portions 760 corresponding thereto. The rib 761 has a shape corresponding to the shapes of the five third relay terminals 400. The left end part of the rib 761 of the third mounting portions 760 is also used for positioning the first relay terminal 200, and the right end part of the rib 761 is also used for positioning the second relay terminal 300.

In the first mounting portion 740, nuts 742 made of metal are embedded at three places. In the second mounting portion 750, nuts 752 made of metal are embedded at three places. In each third mounting portion 760, a nut 762 made of metal is embedded at a center portion.

Each of the left lateral face portion 714 and the right lateral face portion 715 is provided, on the inner side of a front end portion thereof, with a terminal attachment portion 770 which has a cylindrical shape and to which an external connection terminal 500 is attached. A circular opening portion 771 continuous with the terminal attachment portion 770 is formed in each of the left lateral face portion 714 and the right lateral face portion 715. The circular opening of the terminal attachment portion 770 and the opening portion 771 continuous from this opening form a communication hole 770a through which the inside and the outside of the case body 700, i.e., the case 10, are continuous with each other. An external connection terminal 500 is inserted into this communication hole 770a.

At the front of the five third mounting portions 760 in the bottom face portion 711, a placement rib 780 to which the circuit board 600 is placed is provided so as to extend in the left-right direction. The placement rib 780 faces five placement portions 737 with the five third mounting portions 760 therebetween, and has a height equal to that of each placement portion 737. The placement rib 780 is provided with bosses 781 at two places, i.e., left and right. A nut 782 made of metal is embedded in each boss 781.

An opening portion 715a which has a circular shape and which is in communication with the inside of the body part 710 is formed in the right lateral face portion 715. The opening portion 715a is provided with a pressure regulating valve CV.

Between the six holders 730 and the five third mounting portions 760 in the bottom face portion 711, six penetration holes 790 penetrating the bottom face portion 711 are provided so as to be arranged in the left-right direction. Each penetration hole 790 has a quadrangular shape that is long in the left-right direction. The penetration hole 790 has a size that allows passage of a second electrode probe (described later) of a welder.

As shown in FIG. 7B, at the outer face of the bottom face portion 711, a wall portion 791 having a quadrangular frame shape that is long in the left-right direction is provided so as to surround the six penetration holes 790. Although the aforementioned ribs 711a, 711b in the lattice shape are also provided in the region inside the wall portion 791, the height of each of the ribs 711a, 711b in the lattice shape in the inside region is lower than the height of the wall portion 791. Further, the height of the wall portion 791 is lower, by a height corresponding to the thickness of the reverse face cover 850, than the height of the ribs 711a, 711b in the lattice shape in the region outside the wall portion 791.

A boss 792 is formed in a center portion of each of the front wall, the rear wall, the left wall, and the right wall of the wall portion 791. A nut 793 made of metal is embedded in each boss 792. The inner side of the upper end face (leading end face) of the wall portion 791 is lower than the remainder thereof in a stepped manner, and serves as an adhesion margin 794 to which an adhesive (described later) is applied.

In the body part 710, one fixation part 720 is provided at the front lateral face portion 712, and the other fixation part 720 is provided at the rear lateral face portion 713. The front lateral face portion 712 and the rear lateral face portion 713 are the lateral faces in the direction, i.e., the front-rear direction, in which the positive electrode lead terminals 130 and the negative electrode lead terminals 140 of the six power storage devices 100 housed in the body part 710 protrude. It should be noted that no fixation part 720 is provided at the left lateral face portion 714 and the right lateral face portion 715 of the body part 710.

In a plan view, each fixation part 720 has a substantially triangular shape of which the width is reduced in accordance with increase in the distance from the front lateral face portion 712 (the rear lateral face portion 713) of the body part 710. In the fixation part 720, a recess 721 is formed in a center portion thereof. The bottom face of this recess 721 is provided with a mounting hole 722 penetrating the bottom face in the up-down direction. The mounting hole 722 is positioned at the center in the left-right direction of the recess 721, i.e., the fixation part 720. The mounting hole 722 has attached thereto a collar 723 made of metal and for increasing the strength of the hole.

As for the fixation part 720, in order to increase the dimension in the up-down direction, i.e., the thickness, a lightening structure in which a large number of ribs 724, 725 are arranged in a lattice shape is adopted for both of the upper face side and the lower face side of the fixation part 720. The upper face of the fixation part 720 has an inclined face such that the thickness of the leading end portion is slightly smaller than the thickness of the root portion.

The fixation parts 720 are provided one by one to the front lateral face portion 712 and the rear lateral face portion 713, respectively, and in the left-right direction (arrangement direction of the power storage devices 100), the mounting hole 722 is positioned at a center O (see the chain line in FIG. 7A) in the arrangement of the six holders 730, i.e., the arrangement of the six power storage devices 100. That is, the center in the left-right direction of the mounting hole 722 matches the center O. In addition, a width W1 of the root portion, of the fixation part 720, that is in contact with the front lateral face portion 712 (the rear lateral face portion 713) is slightly larger than a width W2 which is the total of the widths of the six holders 730. That is, in the left-right direction, the range in which the fixation part 720 is present is not less than the range in which the six power storage devices 100 are present.

As shown in FIGS. 8A and 8B, the cover 800 is formed in a quadrangular shape, and has substantially the same size as the body part 710 of the case body 700. A front edge portion 801, a rear edge portion 802, a left edge portion 803, and a right edge portion 804 at the reverse face of the cover 800 slightly protrude from the reverse face. Four corner portions of the reverse face of the cover 800 and a center portion of each edge portion 801, 802, 803, 804 are each provided with a mounting portion 805 having a shape corresponding to the boss 716 of the body part 710. A mounting hole 806 is formed in each mounting portion 805. In addition, an insertion hole 807 corresponding to the projection 718 of the body part 710 is formed in the mounting portion 805 of each of the front edge portion 801 and the rear edge portion 802. In the obverse face of the cover 800, the periphery of each mounting hole 806 is recessed.

On the reverse face of the cover 800, five projections 810 are formed so as to be arranged in the left-right direction, at positions corresponding to the five placement portions 737 of the body part 710. The five projections 810 are connected by a rib 811 extending in the left-right direction.

As shown in FIGS. 9A and 9B, the reverse face cover 850 is formed in a quadrangular shape long in the left-right direction, and has a size substantially the same as the outer size of the wall portion 791 of the body part 710. A front edge portion 851, a rear edge portion 852, a left edge portion 853, and a right edge portion 854 at the reverse face of the reverse face cover 850 slightly protrude from the reverse face. A center portion of each edge portion 851, 852, 853, 854 of the reverse face cover 850 is provided with a mounting portion 855 having a shape corresponding to the boss 792 of the wall portion 791. A mounting hole 856 is formed in each mounting portion 855. In the obverse face of the reverse face cover 850, the periphery of each mounting hole 856 is recessed.

Each of the first relay terminal 200, the second relay terminal 300, and the five third relay terminals 400 is a bus bar, and is formed by cutting out a conductive metal plate, e.g., a copper plate, into a predetermined shape and performing processing such as bending on the cut-out plate. The first relay terminal 200, the second relay terminal 300, and the five third relay terminals 400 are terminals for connecting the six power storage devices 100 in series. The first relay terminal 200 and the second relay terminal 300 are coupled to the corresponding external connection terminals 500, respectively.

As shown in FIG. 10A, the first relay terminal 200 includes a terminal connection part 210, a board connection part 220, a first fixation part 230, a second fixation part 240, and a third fixation part 250. The terminal connection part 210 has a slender quadrangular shape, and extends rearward. In a rear end portion of the terminal connection part 210, a projecting portion 211 projecting from the obverse face is formed. The board connection part 220 has a pin shape, is bent substantially perpendicularly to the terminal connection part 210, the first fixation part 230, the second fixation part 240, and the third fixation part 250, and stands in the thickness direction of these. A first mounting hole 231, a second mounting hole 241, and a third mounting hole 251 are formed in the first fixation part 230, the second fixation part 240, and the third fixation part 250, respectively.

As shown in FIG. 10B, the second relay terminal 300 has a shape obtained by inversing the first relay terminal 200 in the left-right direction, and includes a terminal connection part 310, a board connection part 320, a first fixation part 330, a second fixation part 340, and a third fixation part 350. The terminal connection part 310 has a slender quadrangular shape, and extends rearward. In a rear end portion of the terminal connection part 310, a projecting portion 311 projecting from the obverse face is formed. The board connection part 320 has a pin shape, is bent substantially perpendicularly to the terminal connection part 310, the first fixation part 330, the second fixation part 340, and the third fixation part 350, and stands in the thickness direction of these. A first mounting hole 331, a second mounting hole 341, and a third mounting hole 351 are formed in the first fixation part 330, the second fixation part 340, and the third fixation part 350, respectively.

As shown in FIG. 10C, each third relay terminal 400 includes two terminal connection parts 410, i.e., left and right, a board connection part 420, and a fixation part 430. Each terminal connection part 410 has a quadrangular shape, and extends rearward. In a rear end portion of each terminal connection part 410, a projecting portion 411 projecting from the obverse face is formed. The board connection part 420 has a pin shape, is bent substantially perpendicularly to each terminal connection part 410 and the fixation part 430, and stands in the thickness direction of these. A mounting hole 431 is formed in the fixation part 430.

As shown in FIG. 11, the external connection terminal 500 is formed from a metal material, and includes a terminal body part 501 having a bottomed cylindrical shape. A female thread is formed in the inner peripheral face of the terminal body part 501. A coupling terminal part 502 in a flat plate shape and having a mounting hole 502a is formed at a bottom face portion of the terminal body part 501, which is one end side of the external connection terminal 500. Further, a groove 503 in an annular shape is formed in the outer peripheral face of the terminal body part 501, and an O-ring 510 in an annular shape and formed from an elastic material such as rubber is fitted in this groove 503. A connection face 501a to which an external terminal is connected is formed in an opening end portion of the terminal body part 501, which is the other end side of the external connection terminal 500.

In the present embodiment, the external connection terminal 500 on the left side serves as a terminal on the positive electrode side, and the external connection terminal 500 on the right side serves as a terminal on the negative electrode side. In a case where the two external connection terminals 500 are distinguished from each other according to the polarities, the external connection terminal 500 on the left side is a first external connection terminal 500a, and the external connection terminal 500 on the right side is a second external connection terminal 500b, for example.

As shown in FIG. 5B, the circuit board 600 has a rectangular shape that is long in the left-right direction. A first through-hole 601 and a second through-hole 602 are formed in a left end portion and a right end portion of the circuit board 600, respectively. Five third through-holes 603 are formed so as to be arranged in the left-right direction between the first through-hole 601 and the second through-hole 602. The inner side of each of the first through-hole 601, the second through-hole 602, and the third through-holes 603 is metal-plated. An electronic circuit part (not shown) that includes a voltage detection circuit which detects the voltage of each power storage device 100 and a balancing circuit for balancing the voltage of each power storage device 100 in accordance with the voltage detected by the voltage detection circuit is disposed on the circuit board 600. The first through-hole 601, the second through-hole 602, and the third through-holes 603 are connected to the electronic circuit part through a conductive pattern (not shown). Further, two mounting holes 604 are formed in the circuit board 600.

Next, a procedure of assembling the power storage module 1 is described.

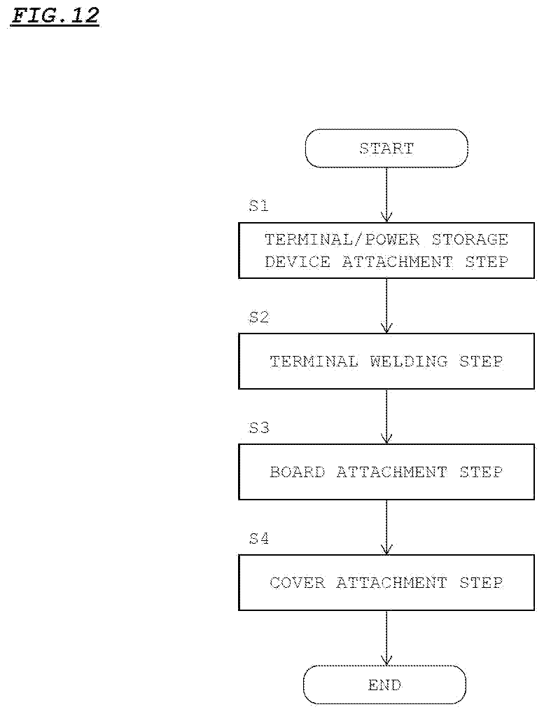

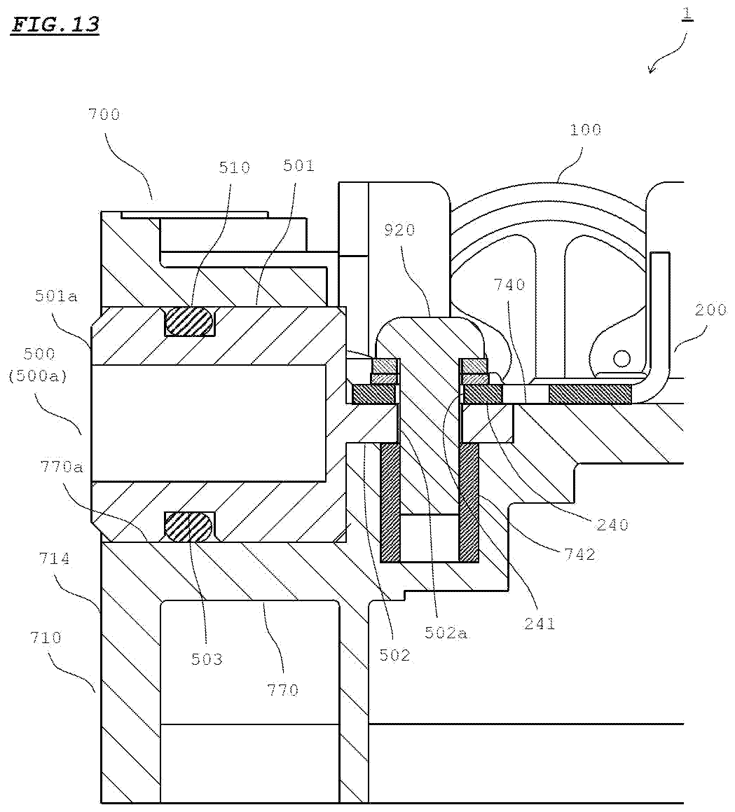

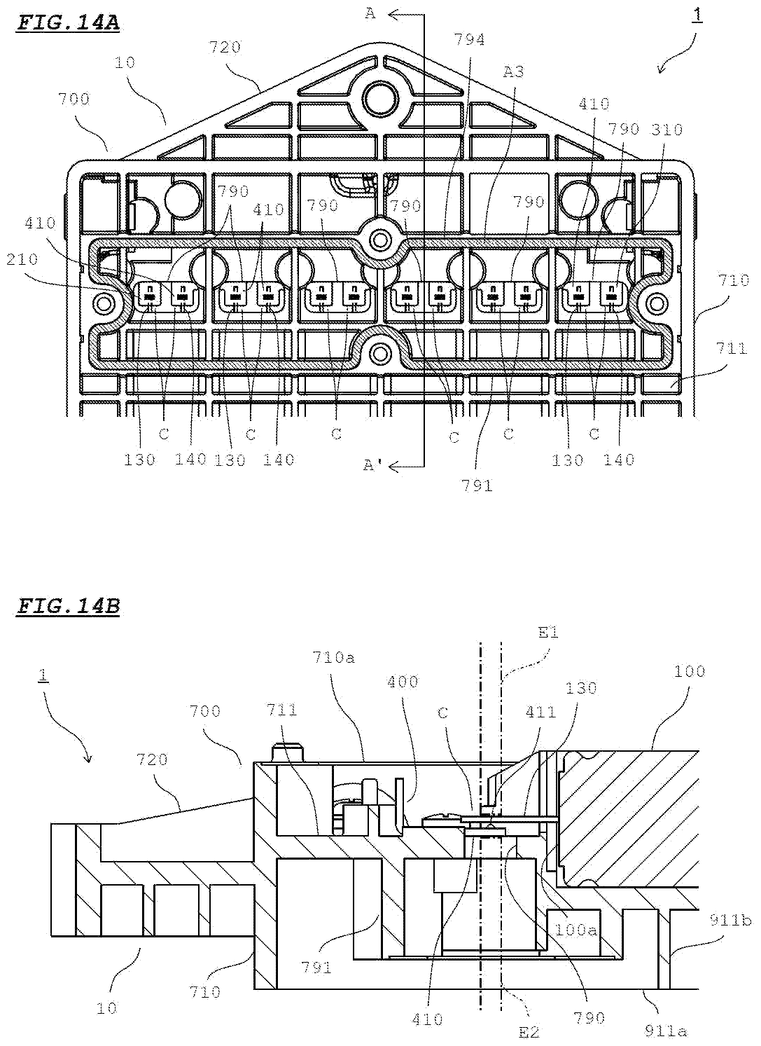

FIG. 12 is a flow chart showing the procedure of assembling the power storage module 1. FIG. 13 is a cross-section of a major part showing the periphery of the terminal attachment portion 770 on the left side after a terminal/power storage device attachment step. FIG. 14A is a bottom view of an upper part of the power storage module 1 after the terminal/power storage device attachment step, and FIG. 14B is an A-A′ cross-sectional view of FIG. 14A. In FIG. 14B, for convenience, a first electrode probe E1 and a second electrode probe E2 are indicated by chain lines. In FIG. 14A, an adhesive A3 is hatched for convenience.

As shown in FIG. 12, the power storage module 1 is assembled by performing the terminal/power storage device attachment step, a terminal welding step, a board attachment step, and a cover attachment step.

First, the terminal/power storage device attachment step is performed (S1). The terminal/power storage device attachment step is composed of a terminal attachment step and a device attachment step subsequent to the terminal attachment step.

In the terminal attachment step, first, as shown in FIG. 4, two external connection terminals 500 are attached to the left and right terminal attachment portions 770 of the case body 700. That is, each external connection terminal 500 is inserted into the communication hole 770a from the outer side. As shown in FIG. 13, in the communication hole 770a, the O-ring 510 is interposed between the outer peripheral face of the external connection terminal 500 and the inner peripheral face of the communication hole 770a. At this time, the width of the groove 503 of the external connection terminal 500 is larger than the width of the O-ring 510 (see FIG. 11). Therefore, the O-ring 510 is easily flattened when the external connection terminal 500 is inserted into the communication hole 770a, whereby smooth insertion can be performed. In this manner, the space between the external connection terminal 500 and the communication hole 770a is sealed by the O-ring 510.

In a state of being attached to the terminal attachment portion 770, the connection face 501a of the first external connection terminal 500a on the left side is parallel to the outer face of the left lateral face portion 714, and slightly protrudes with respect to the outer face. Similarly, the connection face 501a of the second external connection terminal 500b on the right side is parallel to the outer face of the right lateral face portion 715, and slightly protrudes with respect to the outer face.

As shown in FIG. 4, the first relay terminal 200, the second relay terminal 300, and the five third relay terminals 400 are housed in the case body 700 through the opening portion 710a, and mounted to the first mounting portion 740, the second mounting portion 750, and the five third mounting portions 760, respectively. As a result, the seven relay terminals 200, 300, 400 are disposed on the bottom face portion 711 of the case body 700.

At this time, the first relay terminal 200 is positioned by the two ribs 741 of the first mounting portion 740 and the left end part of the rib 761 for the third mounting portions 760, and the first mounting hole 231 and the third mounting hole 251 are aligned with the screw holes of the corresponding nuts 742 of the first mounting portion 740. A screw 910 passed through the first mounting hole 231 is fastened into the nut 742, and a screw 910 passed through the third mounting hole 251 is fastened into the nut 742.

As shown in FIG. 13, the second fixation part 240 of the first relay terminal 200 overlaps, from above, the coupling terminal part 502 of the first external connection terminal 500a on the left side. That is, the first relay terminal 200 and the coupling terminal part 502 are disposed so as to overlap each other in the thickness direction of these. The second mounting hole 241 is aligned with the screw hole of the corresponding nut 742 of the first mounting portion 740 and the mounting hole 502a of the coupling terminal part 502. A screw 920 passed through the second mounting hole 241 and the mounting hole 502a of the first external connection terminal 500a is fastened into the nut 742. Accordingly, the first relay terminal 200 is fixed to the first mounting portion 740, and is coupled to the first external connection terminal 500a.

With respect to the first external connection terminal 500a, the terminal body part 501 as the main part has a cylindrical shape, but the coupling terminal part 502 has a flat plate shape. The coupling terminal part 502 is coupled to the first relay terminal 200, which also has a flat plate shape.

Accordingly, the first external connection terminal 500a can be coupled to the first relay terminal 200 in a favorable manner. This also applies to the coupling between the second external connection terminal 500b and the second relay terminal 300.

Similarly, the second relay terminal 300 is positioned by the two ribs 751 of the second mounting portion 750 and the right end part of the rib 761 for the third mounting portions 760, and the first mounting hole 331 and the third mounting hole 351 are aligned with the screw holes of the corresponding nuts 752 of the second mounting portion 750. A screw 910 passed through the first mounting hole 331 is fastened into the nut 752, and a screw 910 passed through the third mounting hole 351 is fastened into the nut 752.

The second fixation part 340 of the second relay terminal 300 overlaps, from above, the coupling terminal part 502 of the second external connection terminal 500b on the right side, and the second mounting hole 341 is aligned with the screw hole of the corresponding nut 752 of the second mounting portion 750 and the mounting hole 502a of the coupling terminal part 502. A screw 920 passed through the second mounting hole 341 and the mounting hole 502a of the second external connection terminal 500b is fastened into the nut 752. Accordingly, the second relay terminal 300 is fixed to the second mounting portion 750, and is coupled to the second external connection terminal 500b.

Each third relay terminal 400 is positioned by the rib 761 for the third mounting portions 760, and the mounting hole 431 is aligned with the screw hole of the nut 762 of a corresponding third mounting portion 760. A screw 910 passed through the mounting hole 431 is fastened into the nut 762. Accordingly, the third relay terminal 400 is fixed to the third mounting portion 760.

Next, in the device attachment step, as shown in FIG. 4, the six power storage devices 100 are housed in the case body 700 through the opening portion 710a and are attached to the six holders 730 from above. Substantially the entirety of the power storage device 100 is received in the holder 730. At two places of a front end portion, a center portion, and two places of a rear end portion of each holder 730, an adhesive A1 is applied between the peripheral face of the power storage device 100 and the linear portions 732 of the holders 730 on both sides thereof. The adhesive A1 hardens at ordinary temperature, in a state of being adhered to the peripheral face of the power storage device 100 and the linear portions 732. Accordingly, the peripheral face of the power storage device 100 and the linear portions 732 on both sides thereof are coupled by the adhesive A1, whereby the power storage device 100 is fixed to the holder 730, and reinforcement of the opening end side of the holder 730 by using the power storage device 100 having high rigidity is performed.

The positive electrode lead terminal 130 and the negative electrode lead terminal 140 of each power storage device 100 each extend forward through the opening portion 733. The leading end portion of the lead terminal overlaps from above an obverse face 210a, 310a, 410a of the terminal connection part 210, 310, 410 of the corresponding first relay terminal 200, second relay terminal 300, third relay terminal 400, and comes close to or contacts the projecting portion 211, 311, 411 from above. The portion where the lead terminal 130, 140 of each power storage device 100 and the relay terminal 200, 300, 400 overlap each other forms a connection portion C. It should be noted that a reverse face 210b, 310b, 410b of the terminal connection part 210, 310, 410 faces the bottom face portion 711, and the obverse face 210a, 310a, 410a is opposed, back to back, to the reverse face 210b, 310b, 410b. As shown in FIG. 14A, each penetration hole 790 of the bottom face portion 711 of the case body 700 is positioned immediately below two connection portions C, and thus, the two connection portions C are seen through the penetration hole 790 from the outer face side of the bottom face portion 711, i.e., from the outside of the case 10.

When the six power storage devices 100, the first relay terminal 200, the second relay terminal 300, the five third relay terminals 400, and the two external connection terminals 500 have been attached in the case body 700, the terminal/device attachment step is completed.

Next, the terminal welding step is performed (S2). In the terminal welding step, projection welding is performed by using a welder (not shown). The welder includes a first electrode probe E1 and a second electrode probe E2 having different polarities from each other. As shown in FIG. 14B, the first electrode probe E1 is passed through the opening portion 710a of the case body 700 and contacts the lead terminal 130, 140 from above. In addition, the second electrode probe E2 is passed through the penetration hole 790 and contacts the terminal connection part 210, 310, 410 of the relay terminal 200, 300, 400 from below. The first electrode probe E1 and the second electrode probe E2 face each other with the connection portion C therebetween. The lead terminal 130, 140 and the projecting portion 211, 311, 411 of the terminal connection part 210, 310, 410 are pressed by the first electrode probe E1 and the second electrode probe E2, to be in contact each other and pressurized. In this state, current is applied to the first electrode probe E1 and the second electrode probe E2. Large current is concentrated on the projecting portion 211, 311, 411, to melt the projecting portion 211 311, 411, whereby the connection portion C is welded. Accordingly, the positive electrode lead terminals 130 and the negative electrode lead terminals 140 are connected to and fixed to the terminal connection parts 210, 310, 410 of the corresponding relay terminals 200, 300, 400.

In FIG. 14B, the connection portion C between the positive electrode lead terminal 130 of the fourth power storage device 100 from the left and the corresponding third relay terminal 400 is shown.

In this manner, the positive electrode lead terminal 130 and the negative electrode lead terminal 140 of adjacent power storage devices 100 are electrically connected by the relay terminal 200, 300, 400.

Next, the board attachment step is performed (S3). As shown in FIG. 3, the circuit board 600 is mounted in the case body 700, at a position above the five third relay terminals 400. At this time, a front end portion of the circuit board 600 is placed on the placement rib 780, and a rear end portion thereof is placed on the five placement portions 737. The two mounting holes 604 of the circuit board 600 are aligned with the screw holes of the two nuts 782 of the placement rib 780, and screws 930 passed through the respective mounting holes 604 are fastened into the nuts 782. Accordingly, the circuit board 600 is fixed to the placement rib 780. The board connection part 220 of the first relay terminal 200, the board connection part 320 of the second relay terminal 300, and the board connection parts 420 of the five third relay terminals 400 are passed through the first through-hole 601, the second through-hole 602, and the five third through-holes 603 of the circuit board 600, and then electrically connected to the through-holes 601, 602, 603 and fixed to the circuit board 600 by soldering.

As described above, in the present embodiment, in the case body 700, the circuit board 600 and the five third relay terminals 400 each having a substantially flat plate shape are disposed so as to overlap each other in the thickness direction thereof, i.e., the depth (height) direction (arrangement direction of the bottom face portion 711 and the opening portion 710a) of the case body 700. Therefore, the space for disposing these components can be reduced, and the case body 700 can be made compact.

In addition, as described above, the first relay terminal 200, the second relay terminal 300, and each third relay terminal 400 are provided with the board connection parts 220, 320, 420, and these board connection parts 220, 320, 420 are connected to the circuit board 600. In a case where the positive electrode lead terminal 130 and the negative electrode lead terminal 140 are connected to the circuit board 600 as in conventional art, it is a concern that, when the circuit board 600 has deformed due to vibration of the power storage module 1, the lead terminals 130, 140 are broken at the connection portions to the circuit board 600. In this regard, since the board connection part 220, 320, 420 is rigid by having a larger cross-sectional area than the positive electrode lead terminal 130 and the negative electrode lead terminal 140, the board connection part 220, 320, 420 is less likely to be broken when the circuit board 600 has deformed due to vibration of the power storage module 1.

In this manner, the circuit board 600 is electrically connected to the six power storage devices 100 via the first relay terminal 200, the second relay terminal 300, and the third relay terminals 400.

Lastly, the cover attachment step is performed (S4). In the cover attachment step, first, the reverse face cover 850 is attached to the wall portion 791 of the case body 700, and then, the cover 800 is attached to the edge portion 710b of the case body 700.

First, as shown in FIG. 14A, the adhesive A3 having high sealing ability is applied to the adhesion margin 794 at the leading end portion of the wall portion 791. The adhesive A3 is formed from a silicone-based material, and when coming into contact with air at ordinary temperature, hardens to have elasticity.

Next, the reverse face cover 850 is mounted to the wall portion 791 having the adhesive A3 applied thereto, such that the reverse face cover 850 covers the six penetration holes 790. The four mounting holes 856 of the reverse face cover 850 are aligned with the screw holes of the nuts 793 of the four bosses 792 of the wall portion 791. Screws 950 passed through the mounting holes 856 are fastened into the nuts 793, respectively. Accordingly, the reverse face cover 850 is fixed to the wall portion 791. In addition, the reverse face cover 850 and the wall portion 791 are fixed to each other also through adhesion by the adhesive A3. The space between the reverse face cover 850 and the leading end portion of the wall portion 791 is sealed by the adhesive A3. As a result, as shown in FIG. 2, the six penetration holes 790 are closed by the wall portion 791 and the reverse face cover 850 from the outer side of the bottom face portion 711 of the case body 700.

Next, an adhesive A2 is applied to the adhesion margin 719 of the edge portion 710b of the case body 700. The adhesive A2 is the same as the adhesive A3. Then, as shown in FIG. 1, the cover 800 is mounted to the edge portion 710b of the case body 700 having the adhesive A2 applied thereto. At this time, the cover 800 is placed on the case body 700 such that the projections 718 of the case body 700 are inserted into the insertion holes 807 of the cover 800. The cover 800 is positioned with respect to the case body 700, and the eight mounting holes 806 of the cover 800 are aligned with the screw holes of the nuts 717 of the eight bosses 716 of the case body 700. Screws 940 passed through the mounting holes 806 are fastened into the nuts 717, respectively. Accordingly, the cover 800 is fixed to the case body 700. In addition, the cover 800 and the case body 700 are also fixed to each other through adhesion by the adhesive A2. The space between the cover 800 and the case body 700 is sealed by the adhesive A2. As a result, the opening portion 710a of the case body 700 is closed by the cover 800. In the case 10, the five projections 810 of the reverse face of the cover 800 contact the obverse face of a rear end portion of the circuit board 600. Accordingly, the rear end portion of the circuit board 600 is sandwiched from above and below by the projections 810 and the five placement portions 737, thereby being fixed in the up-down direction.

The opening portion 710a is closed by the cover 800, and the six penetration holes 790 are closed by the wall portion 791 and the reverse face cover 850, whereby a state where the inside of the case 10 is tightly sealed is established. That is, the six power storage devices 100 are housed in the case 10 in a state where the six power storage devices 100 are closed from the outside. The pressure inside the case 10 is adjusted so as to be the same as that of the outside, by the pressure regulating valve CV.

Then, the power storage module 1 is completed.

The power storage module 1 can be used, for example, as an auxiliary power supply for electric automobiles and hybrid automobiles. In such a case, as shown in FIG. 1, the power storage module 1 is mounted to a predetermined setting part 2 provided in the vehicle body. At this time, the two fixation parts 720 of the case 10 is fixed by, for example, bolts 3, to a setting face 2a of the setting part 2. The bolts 3 are passed through the mounting holes 722 of the fixation parts 720, and are fastened into the screw holes (not shown) of the setting part 2. External terminals (not shown) on the vehicle body side are fixed, by screwing, to the corresponding connection faces 501a of the two external connection terminals 500 of the power storage module 1.

In the vehicle body, vibration can occur at the time of traveling and the like of the automobile. When vibration has occurred in the vehicle body, the power storage module 1 mounted to the setting part 2 of the vehicle body vibrates. At this time, with respect to the power storage module 1, the body part 710 of the case body 700 is fixed to the setting part 2 by the fixation parts 720 provided at the front lateral face portion 712 and the rear lateral face portion 713, and thus, in the front-rear direction, the body part 710 is less likely to be deflected upwardly and downwardly in accordance with the vibration. As for the six power storage devices 100 housed in the body part 710, the direction in which the positive electrode lead terminal 130 and the negative electrode lead terminal 140 protrude from the end face (the sealing body 120) of each power storage device 100 is the front-rear direction. Therefore, the positive electrode lead terminal 130 and the negative electrode lead terminal 140 are less likely to be deflected upwardly and downwardly. Thus, cracks, separations, and the like are less likely to occur in the connection portions (welded portions) between the positive electrode lead terminal 130 and the negative electrode lead terminal 140, and the terminal connection parts 210, 310, 410 of the first relay terminal 200, the second relay terminal 300, and the third relay terminals 400.

In addition, it is conceivable that, when dew condensation or the like has occurred around the power storage module 1, water resulting from the dew condensation attaches to the power storage module 1. However, the power storage module 1 has a configuration in which the power storage devices 100 are housed in the case 10 that is closed (tightly sealed) from the outside. Thus, that the power storage devices 100 come into contact with water to be wetted is less likely to occur.

### <Effect of Embodiment>

According to the present embodiment, the following effects can be exhibited.

With respect to the case 10, the fixation parts 720 for mounting the power storage module 1 to the setting part 2 is provided at the front lateral face portion 712 and the rear lateral face portion 713, which are both lateral faces in the direction (the front-rear direction) in which the positive electrode lead terminals 130 and the negative electrode lead terminals 140 in the body part 710 protrude. Accordingly, when the power storage module 1 has vibrated, the body part 710 is less likely to be deflected upwardly and downwardly in accordance with the vibration and the positive electrode lead terminals 130 and the negative electrode lead terminals 140 are less likely to be deflected upwardly and downwardly, in the direction in which the positive electrode lead terminals 130 and the negative electrode lead terminals 140 protrude. Therefore, cracks, separations, and the like are less likely to occur in the connection portions between the positive electrode lead terminals 130 and the negative electrode lead terminals 140, and the terminal connection parts 210, 310, 410 of the first relay terminal 200, the second relay terminal 300, and the third relay terminals 400.

Thus, since the power storage module 1 has an increased vibration resistance for the lead terminals 130, 140, there is no need to increase the rigidity of the entirety of the case 10, and reduction of the weight and thickness of the case 10 is facilitated.

In particular, the positive electrode lead terminal 130 and the negative electrode lead terminal 140 each have a small diameter. Thus, when having been deflected upwardly and downwardly, the positive electrode lead terminal 130 and the negative electrode lead terminal 140 may easily be broken in the vicinity of the connection portions. In this regard, in the present embodiment, since the positive electrode lead terminal 130 and the negative electrode lead terminal 140 are less likely to be deflected upwardly and downwardly, breakage thereof is also less likely to occur.

Since the fixation parts 720 are formed integrally with the body part 710, rattling between the body part 710 and the fixation parts 720 does not occur, and the body part 710 can be firmly fixed in the direction in which the positive electrode lead terminals 130 and the negative electrode lead terminals 140 protrude.

Further, since the fixation parts 720 are provided one by one to the front lateral face portion 712 and the rear lateral face portion 713 of the body part 710, respectively, work of fixing the case 10 to the setting part 2 can be reduced. In addition, the mounting holes 722 of the respective fixation parts 720 are positioned at the center O of the arrangement of the six power storage devices 100. Therefore, in the range in which the six power storage devices 100 are arranged, the force with which the body part 710 is fixed via the fixation parts 720 is less likely be biased. Accordingly, in the six power storage devices 100, up-down deflections of the positive electrode lead terminals 130 and the negative electrode lead terminals 140 can be suppressed in a favorable manner, and cracks, separations, and the like in the connection portions can be suppressed in a favorable manner.

Further, in the direction (the left-right direction) in which the six power storage devices 100 are arranged, the range (the width W1) in which each fixation part 720 is present is not less than the range (the width W2) in which the six power storage devices 100 are present. Accordingly, the range of the front lateral face portion 712 and the rear lateral face portion 713 corresponding to the range in which the six power storage devices 100 are present is firmly fixed to the setting part 2 via the fixation parts 720. Thus, in the six power storage devices 100, up-down deflections of the positive electrode lead terminals 130 and the negative electrode lead terminals 140 can be suppressed in a favorable manner, and cracks, separations, and the like at the connection portions can be suppressed in a favorable manner.

Further, each fixation part 720 has a triangular shape of which the width is reduced in accordance with increase in the distance from the front lateral face portion 712 (the rear lateral face portion 713) of the body part 710. Therefore, the body part 710 can be firmly fixed to the setting part 2 at the root portion of each fixation part 720, and at the same time, the volume of the entirety of fixation part 720 can be reduced. Thus, in accordance with the reduction, the case 10 can be downsized, and the material of the case 10 can be reduced.

The power storage module 1 includes: the case 10 in which a plurality of power storage devices 100 are housed in a state of being arranged; and the relay terminals 200, 300, 400 which are housed in the case 10 and to which the lead terminals 130, 140 protruding from the end faces of the plurality of respective power storage devices 100 are connected. The case 10 includes the bottom face portion 711; and the opening portion 710a which faces the bottom face portion 711 and through which the plurality of power storage devices 100 are passed when being housed into the case 10. In the bottom face portion 711, each of the penetration holes 790 penetrating the bottom face portion 711 is provided at a position at which the connection portion C between the lead terminal 130, 140 and the relay terminal 200, 300, 400 is seen through the penetration hole 790 from the outside of the case 10. The relay terminal 200, 300, 400 is disposed on the bottom face portion 711, the lead terminal 130, 140 overlaps the obverse face 210a, 310a, 410a of the relay terminal 200, 300, 400, the overlapping portion forms the connection portion C, and this connection portion C is welded.

According to this configuration, when the power storage module 1 is to be assembled, the first electrode probe El passed through the opening portion 710a and the second electrode probe E2 passed through a penetration hole 790 are caused to face each other with the connection portion C therebetween, whereby the connection portion C can be welded by using the first electrode probe E1 and the second electrode probe E2. Therefore, in a state where the plurality of power storage devices 100 and the relay terminals 200, 300, 400 are disposed in the case 10, the connection portion C between the lead terminal 130, 140, and the relay terminal 200, 300, 400 can be smoothly welded.

Further, the case 10 includes: as a first closing part for closing the opening portion 710a, the cover 800 attached to the edge portion 710b surrounding the opening portion 710a; and as a second closing part for closing the penetration holes 790, the wall portion 791 provided at the outer face of the bottom face portion 711 so as to surround the penetration holes 790, and the reverse face cover 850 attached to the leading end portion of the wall portion 791.

According to this configuration, by the opening portion 710a and the penetration holes 790 being closed, a state where the inside of the case 10 is closed from the outside can be established. Therefore, even when dew condensation or the like has occurred around the power storage module 1, water resulting therefrom is less likely to enter the case 10, and the plurality of power storage devices 100 and other components housed in the case 10 can be protected from water.

Further, the space between the cover 800 and the edge portion 710b is sealed by the adhesive A2, and the space between the reverse face cover 850 and the leading end portion of the wall portion 791 is sealed by the adhesive A3.

According to this configuration, entry of water into the case 10 from the space between the cover 800 and the edge portion 710b and the space between the reverse face cover 850 and the leading end portion of the wall portion 791 can be prevented.

Further, the relay terminal 200, 300, 400 includes the terminal connection part 210, 310, 410 extending toward the lead terminal 130, 140 side along the direction in which the lead terminal 130, 140 protrudes, and the terminal connection part 210, 310, 410 and the lead terminal 130, 140 overlap each other to form the connection portion C.

According to this configuration, the connection portion C can be made long. Thus, a sufficient welding margin can be obtained, and connection strength by the welding can be increased.

Further, the power storage module 1 includes the circuit board 600 which is electrically connected to the plurality of power storage devices 100 via the relay terminals 200, 300, 400. The circuit board 600 is disposed in the case 10 so as to overlap the relay terminals 200, 300, 400 in the arrangement direction of the bottom face portion 711 and the opening portion 710a. The relay terminal 200, 300, 400 includes the board connection part 220, 320, 420 protruding in the arrangement direction, and the board connection part 220, 320, 420 is inserted into the through-hole 601, 602, 603 of the circuit board 600, thereby being electrically connected and fixed.

According to this configuration, the case 10 can be made compact.

Further, the power storage module 1 includes: the communication hole 770a which is provided in the case 10 and through which the inside and the outside of the case 10 are continuous with each other; the external connection terminal 500 inserted in the communication hole 770a, one end side of the external connection terminal 500 being electrically connected to the relay terminal 200, 300 inside the case 10, the other end side of the external connection terminal 500 being exposed to the outside of the case 10 to be connected to an external terminal; and the O-ring 510 interposed between the outer face of the external connection terminal 500 and the inner face of the communication hole 770a. The external connection terminal 500 includes the first external connection terminal 500a and the second external connection terminal 500b having different polarities from each other. A communication hole 770a into which the first external connection terminal 500a is inserted and a communication hole 770a into which the second external connection terminal 500b is inserted are respectively provided in the left lateral face portion 714 and the right lateral face portion 715, of the case 10, that face each other.

According to this configuration, entry of water into the case 10 from the space between the external connection terminal 500 (the first external connection terminal 500a, the second external connection terminal 500b) and the communication hole 770a can be prevented.

Further, the coupling terminal part 502 in a plate shape is formed at one end side of the external connection terminal 500, and the relay terminal 200, 300 and the coupling terminal part 502 are disposed so as to overlap each other in the thickness direction of the relay terminal 200, 300 and the coupling terminal part 502, and are coupled by a screw 920.

According to this configuration, the coupling terminal part 502 in a flat plate shape is coupled to the relay terminal 200, 300, which is also in a flat plate shape, and thus, the external connection terminal 500 can be coupled to the relay terminal 200, 300 in a favorable manner.

Further, in the external connection terminal 500, on the other end side thereof, the connection face 501a which is parallel to the outer face of the case 10 and to which an external terminal is connected is formed, and the connection face 501a protrudes with respect to the outer face of the case 10.

In a case where the connection face 501a is recessed with respect to the outer face of the case 10, when an external terminal is connected to the connection face 501a from the outer face side by means of a screw or the like, the external terminal contacts the outer face, and thus, outwardly pulling force is likely to be applied to the external connection terminal 500.

In this regard, in a configuration in which the connection face 501a protrudes with respect to the outer face of the case 10, the outwardly pulling force is less likely to be applied to the external connection terminal 500 when the external terminal is connected to the connection face 501a from the outer face side by means of a screw or the like. Accordingly, there is no need to be concerned about damage, due to such a force, of the external connection terminal 500 and the like.

Although an embodiment of the present invention has been described, the present invention is not limited to the above embodiment. Various application examples of the present invention can be made in addition to the above embodiment.

### <Modification 1>

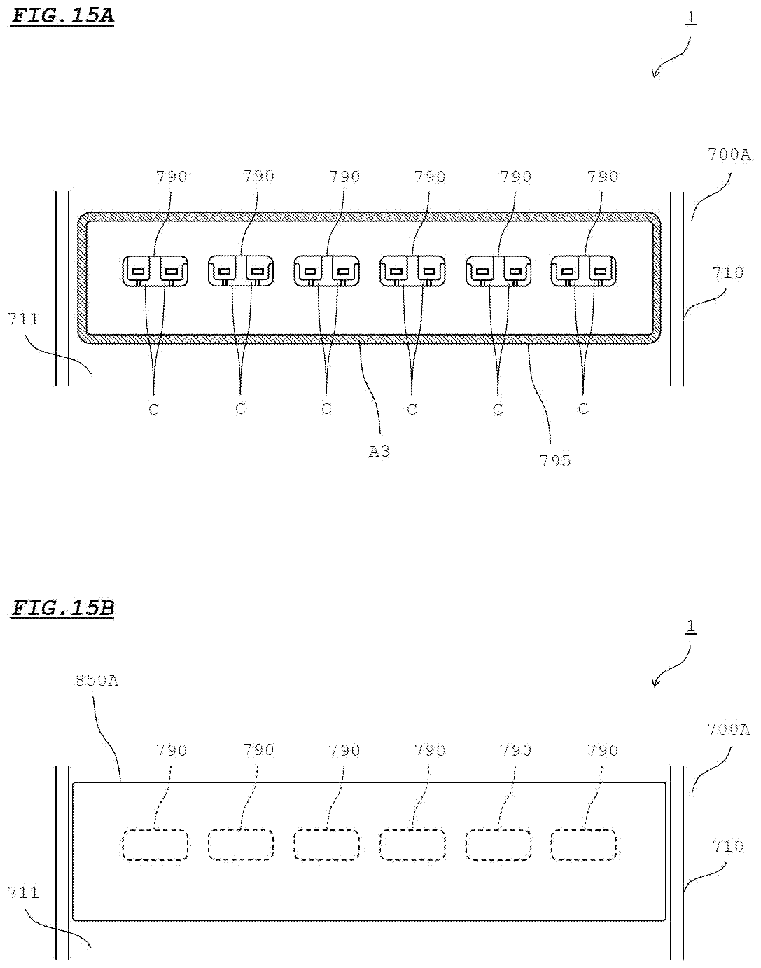

FIGS. 15A and 15B are bottom views of a major part of the power storage module 1 showing a peripheral portion of the six penetration holes 790 before a reverse face cover 850A is attached and after the reverse face cover 850A is attached, according to Modification 1. In FIG. 15A, the adhesive A3 is hatched for convenience.

In the above embodiment, in the case body 700, the six penetration holes 790 are closed by the wall portion 791 and the reverse face cover 850.

In contrast, in a case body 700A of the present modification, the wall portion 791 is not provided, an adhesion margin 795 slightly recessed from the face therearound is provided on the outer face of the bottom face portion 711 so as to surround the six penetration holes 790, and the adhesive A3 is applied to this adhesion margin 795. Then, the reverse face cover 850A is attached to the outer face of the bottom face portion 711 so as to cover the six penetration holes 790. The reverse face cover 850A is fixed to the outer face of the bottom face portion 711 by the adhesive A3. In addition, the space between the reverse face cover 850A and the outer face of the bottom face portion 711 is sealed by the adhesive A3. It should be noted that, similar to the above embodiment, the reverse face cover 850A may be fixed by screws together with the adhesive A3.

According to the configuration of the present modification, similar to the above embodiment, entry of water into the case 10 from the penetration holes 790 can be prevented.

In the present modification, the reverse face cover 850A corresponds to “second closing part” and “second lid” described in the claims.

### <Other Modifications>

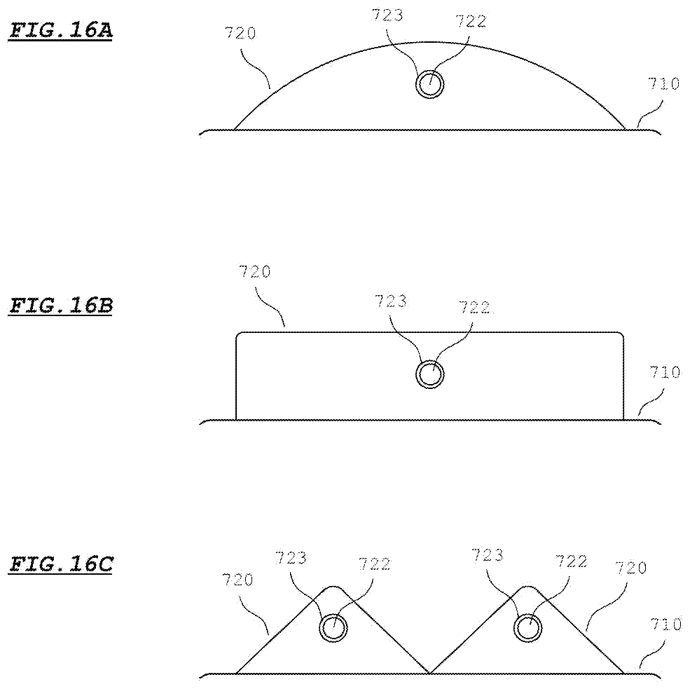

In the above embodiment, each fixation part 720 is formed in a triangular shape (isosceles triangular shape). However, the fixation part 720 may be formed in a shape different from the above shape. For example, as shown in FIG. 16A, the fixation part 720 may be formed in a circular arc shape. Alternatively, as shown in FIG. 16B, the fixation part 720 may be formed in a quadrangular shape. In a case where the fixation part 720 is formed in a circular arc shape, although effects are reduced when compared with a case where the fixation part 720 is formed in a triangular shape, the body part 710 can be firmly fixed to the setting part 2 by the root portion of the fixation part 720 and at the same time, the volume of the entirety of the fixation part 720 can be reduced. It should be noted that, in FIGS. 16A and 16B, the fixation part 720 is schematically depicted.

In the above embodiment, the fixation parts 720 are provided one by one at the front lateral face portion 712 and the rear lateral face portion 713 of the body part 710, respectively. However, as shown in FIG. 16C, a plurality of, e.g., two, fixation parts 720 may be provided at each of the front lateral face portion 712 and the rear lateral face portion 713. It should be noted that, in FIG. 16C, the fixation part 720 is schematically depicted.

Further, in the above embodiment, the range (the width W1) in which each fixation part 720 is present in the direction (the left-right direction) in which the six power storage devices 100 are arranged is not less than the range (the width W2) in which the six power storage devices 100 are present. However, the range in which the fixation part 720 is present may be less than the range in which the six power storage devices 100 are present.

Further, in the above embodiment, the collar 723 is provided at the mounting hole 722 of the fixation part 720. However, a nut may be provided at the mounting hole 722 of the fixation part 720.

Further, in the above embodiment, each fixation part 720 is formed integrally with the body part 710. However, the fixation part 720 may be formed separately from the body part 710 and may be mounted to the body part 710. In this case, the fixation part 720 can be made from a material, e.g., metal, different from that of the body part 710. In a case where the fixation part 720 is formed separately from the body part 710, and when, in particular, the fixation part 720 is formed from a metal plate, the fixation part 720 may be referred to as a bracket. In this case, the case 10 includes the body part 710 and the bracket.

Further, in the above embodiment, the connection portion C between the lead terminal 130, 140 of each power storage device 100 and the relay terminal 200, 300, 400 is connected and fixed by projection welding. However, as long as welding is performed by using a first welding member passed through the opening portion 710a and a second welding member passed through a penetration hole 790, the connection portion C may be connected and fixed by welding other than projection welding.

Further, in the above embodiment, for the 12 connection portions C, the six penetration holes 790 are provided in the bottom face portion 711. That is, one penetration hole 790 corresponds to two connection portions C. However, the number of connection portions C that one penetration hole 790 corresponds to is not limited to the above-mentioned number. For example, three penetration holes 790 may be provided in the bottom face portion 711 such that one penetration hole 790 corresponds to four connection portions C, or one penetration hole 790 may be provided in the bottom face portion 711 such that one penetration hole 790 corresponds to 12 connection portions C.

Further, in the above embodiment, the space between the edge portion 710b and the cover 800 is sealed by the adhesive A2, and the space between the leading end portion of the wall portion 791 and the reverse face cover 850 is sealed by the adhesive A3. However, not limited thereto, another sealing member such as a gasket or a packing may be used instead of the adhesive A2, A3.

Further, in the above embodiment, the O-ring 510 is used for water sealing between the external connection terminal 500 and the communication hole 770a. However, another sealing member, e.g., an annular packing, may be used.

Further, in the above embodiment, the second fixation part 240, 340 of the relay terminal 200, 300 is disposed so as to overlap, from above, the coupling terminal part 502 of the external connection terminal 500. However, conversely, the second fixation part 240, 340 of the relay terminal 200, 300 may be disposed so as to overlap, from below, the coupling terminal part 502 of the external connection terminal 500.

Further, in the above embodiment, the power storage device 100 is configured such that the lead terminal 130, 140 (positive electrode lead terminal 130, negative electrode lead terminal 140) protrudes from the end face 100a of the power storage device 100. However, the power storage device 100 may be configured such that a terminal part other than the lead terminal 130, 140, e.g., a terminal part being shorter and having a larger diameter than the lead terminal 130, 140, protrudes from the end face 100a of the power storage device 100.

Further, in the above embodiment, six power storage devices 100 are used in the power storage module 1. However, not limited thereto, another number of power storage devices 100 may be used in the power storage module 1. In addition, the power storage module 1 may be configured such that these plurality of power storage devices 100 are connected in parallel, instead of being connected in series.

Other than these, various changes can be made as appropriate to the embodiment of the present invention, within the scope of the technical idea described in the claims.

In the description of the above embodiment, the terms that indicate directions such as “up” and “down” are relative directions that are dependent only on the relative positional relationship between component members, and do not indicate absolute directions such as the vertical direction and the horizontal direction.

### INDUSTRIAL APPLICABILITY

The present invention is useful for power storage modules that are used in various types of electronic apparatuses, electric apparatuses, industrial apparatuses, electrical equipment for vehicles, and the like.

### DESCRIPTION OF THE REFERENCE CHARACTERS

1 power storage module
2 setting part
10 case
100 power storage device
100a end face (first end face)
100b end face (second end face)
130 positive electrode lead terminal (terminal part, first terminal part)
140 negative electrode lead terminal (terminal part, second terminal part)
200 first relay terminal (bus bar)
210 terminal connection part (extension part)
210a obverse face (second face)
210b reverse face (first face)
220 board connection part (protrusion part)
300 second relay terminal (bus bar)
310 terminal connection part (extension part)
310a obverse face (second face)
310b reverse face (first face)
320 board connection part (protrusion part)
400 third relay terminal (bus bar)
410 terminal connection part (extension part)
410a obverse face (second face)
410b reverse face (first face)
420 board connection part (protrusion part)
500 external connection terminal
500a first external connection terminal
500b second external connection terminal
501a connection face
502 coupling terminal part
510 O-ring (sealing member)
600 circuit board
601 through-hole (hole portion)
602 through-hole (hole portion)
603 through-hole (hole portion)
700 case body
700A case body
710 body part
710a opening portion
710b edge portion
711 bottom face portion
714 left lateral face portion (lateral face portion)
715 right lateral face portion (lateral face portion)
720 fixation part
722 mounting hole (mounting portion)
770a communication hole
790 penetration hole
791 wall portion (second closing part)
800 cover (first closing part, first lid)
850 reverse face cover (second closing part, second lid)
850A reverse face ccver (second closing part, second lid)
920 screw (coupling member)
A2 adhesive (first sealing part)
A3 adhesive (second sealing part)
C connection portion
E1 first electrode probe (first electrode member)
E2 second electrode probe (second electrode member)

1. A power storage module configured to be mounted to a predetermined setting part, the power storage module comprising:
a plurality of power storage devices; and
a case in which the plurality of power storage devices are housed in a state of being arranged, wherein
each of the plurality of power storage devices includes a first end face and a second end face opposed, back to back, to the first end face, and includes a terminal part protruding from the first end face,
the case includes
a body part in which the plurality of power storage devices are housed, and
a fixation part configured to mount the power storage module to the setting part, and
the fixation part is provided at each of both lateral faces in a direction in which the terminal part in the body part protrudes.

2. The power storage module according to claim 1, wherein
the direction in which the terminal part in the body part protrudes is a direction identical to a direction connecting the first end face and the second end face.

3. The power storage module according to claim 1, wherein
the terminal part includes a lead terminal.

4. The power storage module according to claim 1, wherein
the fixation part is formed integrally with the body part.

5. The power storage module according to claim 1, wherein
the plurality of power storage devices are arranged, in the case, in a direction orthogonal to the direction in which the terminal part protrudes,
the fixation part includes a mounting portion configured to mount and fix the power storage module to the setting part, and
the mounting portion is positioned, in the direction in which the plurality of power storage devices are arranged, at a center of arrangement of the plurality of power storage devices.

6. The power storage module according to claim 1, wherein
the plurality of power storage devices are arranged, in the case, in a direction orthogonal to the direction in which the terminal part protrudes, and
in the direction in which the plurality of power storage devices are arranged, a range in which the fixation part is present is not less than a range in which the plurality of power storage devices are present.

7. The power storage module according to claim 1, wherein
the fixation part has a triangular shape of which a width is increased toward the body part.

8. A power storage module comprising:
a plurality of power storage devices;
a case in which the plurality of power storage devices are housed in a state of being arranged; and
a bus bar which is housed in the case, and to which a terminal part protruding from an end face of each of the plurality of power storage devices is connected, wherein
the case includes a bottom face portion, and an opening portion which faces the bottom face portion and through which the plurality of power storage devices are passed when being housed into the case, and
in the bottom face portion, a penetration hole penetrating the bottom face portion is provided at a position at which a connection portion between the terminal part and the bus bar is seen through the penetration hole from outside of the case.

9. The power storage module according to claim 8, wherein
the bus bar includes a first face disposed on the bottom face portion and facing the bottom face portion, and a second face opposed, back to back, to the first face,
a portion in which the second face of the bus bar and the terminal part overlap each other forms the connection portion, and
the connection portion is welded.

10. The power storage module according to claim 8 erg, wherein
the case includes a first closing part configured to close the opening portion, and a second closing part configured to close the penetration hole.

11. The power storage module according to claim 10, wherein
the first closing part includes a first lid configured to be attached to an edge portion surrounding the opening portion,
a space between the first lid and the edge portion is sealed by a first sealing part,
the second closing part includes a wall portion provided at an outer face of the bottom face portion so as to surround the penetration hole, and a second lid configured to be attached to a leading end portion of the wall portion, and
a space between the second lid and the leading end portion of the wall portion is sealed by a second sealing part.

12. The power storage module according to claim 10, wherein
the first closing part includes a first lid configured to be attached to an edge portion surrounding the opening portion,
a space between the first lid and the edge portion is sealed by a first sealing part,
the second closing part includes a second lid configured to be attached to an outer face of the bottom face portion, and
a space between the second lid and the outer face of the bottom face portion is sealed by a second sealing part.

13. The power storage module according to claim 8, wherein
the bus bar includes an extension part extending toward the terminal part side along a direction in which the terminal part protrudes, and
the extension part and the terminal part overlap each other to form the connection portion.

14. The power storage module according to claim 8, wherein
the terminal part includes a first terminal part and a second terminal part having different polarities from each other, and
the bus bar electrically connects the first terminal part and the second terminal part of the power storage devices that are adjacent to each other.

15. The power storage module according to claim 8, further comprising
a circuit board configured to be electrically connected to the plurality of power storage devices via the bus bar, wherein
the circuit board is disposed in the case so as to overlap the bus bar in an arrangement direction of the bottom face portion and the opening portion.

16. The power storage module according to claim 15, wherein
the bus bar includes a protrusion part protruding in the arrangement direction,
the circuit board includes a hole portion into which the protrusion part is inserted, and
the protrusion part is inserted in the hole portion to be electrically connected thereto and fixed to the circuit board.

17. A power storage module production method comprising:
a step of housing, inside a case including a bottom face portion and an opening portion facing the bottom face portion, a bus bar and a plurality of power storage devices through the opening portion, and of bringing together the bus bar and a terminal part protruding from an end face of each of the plurality of power storage devices; and
a step of causing a first welding member passed through the opening portion and a second welding member passed through a penetration hole penetrating the bottom face portion to face each other with a connection portion therebetween, the connection portion having been formed by bringing the terminal part and the bus bar together, and of welding the connection portion by using the first welding member and the second welding member.

18. The power storage module production method according to claim 17, wherein
in the step of bringing the terminal part and the bus bar together,
the bus bar is housed in the case and disposed on the bottom face portion, and
the plurality of power storage devices are housed in the case and each terminal part is disposed so as to overlap the bus bar.

19. The power storage module production method according to claim 17, further comprising
a step of, after the connection portion has been welded, closing the opening portion by a first closing part, and closing the penetration hole by a second closing part.

20. The power storage module production method according to claim 17, further comprising
a step of, after the connection portion has been welded, disposing, in the case, a circuit board configured to be electrically connected to the plurality of power storage devices via the bus bar such that the circuit board overlaps the bus bar in an arrangement direction of the bottom face portion and the opening portion.

21. A power storage module comprising:
a plurality of power storage devices;
a case in which the plurality of power storage devices are housed in a state of being closed from outside;
a bus bar housed in the case and configured to be electrically connected to each of the plurality of power storage devices;
a communication hole which is provided in the case and through which inside and outside of the case are continuous with each other;
an external connection terminal configured to be inserted into the communication hole, one end side of the external connection terminal being configured to be electrically connected to the bus bar inside the case, another end side of the external connection terminal being configured to be exposed to outside of the case to be connected to an external terminal; and
an annular sealing member interposed between an outer face of the external connection terminal and an inner face of the communication hole.

22. The power storage module according to claim 21, wherein
the external connection terminal includes a first external connection terminal and a second external connection terminal having different polarities from each other, and
the communication hole into which the first external connection terminal is inserted and the communication hole into which the second external connection terminal is inserted are respectively provided in lateral face portions, of the case, that face each other.

23. The power storage module according to claim 21, wherein
a coupling terminal part in a plate shape is formed at the one end side of the external connection terminal, and
the bus bar and the coupling terminal part are disposed so as to overlap each other in a thickness direction of the bus bar and the coupling terminal part, and are coupled by a coupling member.

24. The power storage module according to claim 21, wherein
in the external connection terminal, a connection face which is parallel to an outer face of the case and to which the external terminal is connected is formed on the other end side, and
the connection face protrudes with respect to the outer face of the case.
